(19) United States
(12) Patent Application Publication
(10) Pub. No.: US 2021/0364647 A1
(43) Pub. Date: Nov. 25, 2021

(54) APPARATUS THAT ESTIMATES POSITION AND POSTURE OF MOBILE BODY, PROGRAM FOR THE SAME, SYSTEM THAT ESTIMATES THE POSITION AND THE POSTURE OF THE MOBILE BODY, AND METHOD FOR THE SAME

(71) Applicant: TERRA DRONE CORPORATION, Tokyo (JP)

(72) Inventor: Taro SUZUKI, Tokyo (JP)

(73) Assignee: TERRA DRONE CORPORATION, Tokyo (JP)

(21) Appl. No.: 16/469,873

(22) PCT Filed: Apr. 19, 2019
(86) PCT No.: PCT/JP2019/016877

§ 371 Date: Jun. 14, 2019

(30) Foreign Application Priority Data
Jul. 6, 2018 (JP) 2018-129549

(51) Int. Cl. G01S 19/25; G01S 19/44; G01S 19/15; B64C 39/02

(52) U.S. Cl. CPC G01S 19/252; G01S 19/44; B64C 2201/145; B64C 39/024; G01S 19/15

(57) ABSTRACT

Three or more receivers installed in a UAV receive signals from a number of satellites, and generate, based on these received signals, observation data items including information items about distances from the satellites to the receivers. An information processing apparatus calculates, based on these observation data items and on position data items of the plurality of satellites, estimated reception positions at which one or more of the receivers are estimated to receive the signals from the satellites. The information processing apparatus calculates, based on these estimated reception positions and on an estimated posture of the UAV, estimated positions of a ranging apparatus in the UAV. The ranging apparatus measures a distance to a target by applying a laser beam to the target in synchronization with timings at which the receivers receives the signals from the satellites.

### TECHNICAL FIELD

The present disclosure relates to an apparatus that estimates a position and a posture of a mobile body, a program for the same, a system that estimates the position and the posture of the mobile body, and a method for the same. More specifically, the present disclosure relates to an apparatus that estimates positions and postures of mobile bodies such as a drone that is used for surveying.

### BACKGROUND ART

General aerial surveying includes capturing the ground with a camera or a line sensor installed in an aircraft, and generating a map from taken images. (refer, for example, to Patent Literature 1 below). Further, in recent years, aerial surveying including using UAVs (unmanned aerial vehicles) such as a drone has been put to practical use.

### CITATION LIST

### Patent Literature

PTL 1: Japanese Patent Application Laid-Open No. 10-153426

### SUMMARY OF INVENTION

### Technical Problem

In order to generate an accurate map from the images of the ground, which are taken with use of the UAVs, in general, it is necessary to set markers called GCPs (ground control points) on the ground in advance, and to correct the map by utilizing position information items of the GCPs depicted in the images. Thus, there are problems such as time and effort in setting the GCPs, and incompatibility with environments where the GCPs cannot be set.

Meanwhile, in recent years, a method of measuring a distance from the UAV to the ground with use of a laser scanner installed in the UAV has been put to practical use. This method enables surveying to be conducted without the setting of the GCPs, but it is required to estimate a position and a posture of the UAV with high accuracy. At least the accuracy in estimating the position and the posture can be increased by using a high-accuracy GNSS (global navigation satellite system) receiver and a high-accuracy IMU (inertial measurement unit). However, when such high-accuracy devices are used, there arises a problem of an increase in manufacturing cost. Further, these devices are different from each other in measurement principle, and different from each other in point of consideration to exhibit desired performance. Thus, when both the GNSS receiver and the IMU are installed in the UAV for the measurement, there is a problem of difficulties in satisfying performance demands for both the devices in various measurement environments. In addition, data items to be measured by the GNSS receiver and the IMU are different from each other in property, and hence there is another problem of complication of data processing.

In view of such circumstances, the present disclosure has been made to achieve an object to provide an apparatus and a program that enable estimation of a position and a posture of a low-cost mobile body with high accuracy with use of observation data items that are acquired by the low-cost mobile body, and to provide a system and a method that enable the estimation of the position and the posture of the low-cost mobile body with high accuracy.

### Solution to Problem

A first aspect of the present disclosure relates to an apparatus that estimates a position and a posture of a mobile body. The apparatus according to the first aspect include:

a posture estimation unit that estimates the posture of the mobile body
based on observation data items generated based on signals that “N” (N is an integer number of three or more) receivers installed in the mobile body each have received from a plurality of satellites, and
based on position data items of the plurality of satellites; and

a position estimation unit that estimates the position of the mobile body based on the observation data items and on the position data items.

The observation data items include information items about distances between the plurality of satellites and “N” reception positions at which the “N” receivers receive the signals from the plurality of satellites.

The position estimation unit
calculates, based on the position data items and on the observation data items, two or more estimated reception positions at which two or more receivers of the “N” receivers are estimated to receive the signals from the plurality of satellites,
determines, based on a determination criterion for displacements between the two or more reception positions of the two or more receivers and the two or more estimated reception positions of the two or more receivers, whether or not each of the two or more estimated reception positions is proper, and
calculates estimated positions of a reference point in the mobile body
   based on ones of the estimated reception positions, the ones being determined to be proper by the determination, and
   based on the posture of the mobile body, the posture being estimated by the posture estimation unit.

A second aspect of the present disclosure relates to an apparatus that estimates a position and a posture of a mobile body. The apparatus according to the second aspect includes:

a posture estimation unit that estimates the posture of the mobile body
based on observation data items generated based on signals that “N” (N is an integer number of three or more) receivers installed in the mobile body each have received from a plurality of satellites, and
based on position data items of the plurality of satellites; and

a position estimation unit that estimates the position of the mobile body based on the observation data items and on the position data items.

The observation data items include
information items about distances between the plurality of satellites and “N” reception positions at which the “N” receivers receive the signals from the plurality of satellites, and
information items about signal-to-noise ratios of received signals from the plurality of satellites.

The position estimation unit
calculates, based on the observation data items including the information items about the signal-to-noise ratios, a score indicating a degree of a variation of the signal-to-noise ratios of the received signals at a same time point and from a same one of the plurality of satellites among the “N” receivers, the score being calculated with respect to each of the plurality of satellites,
determines, based on the score calculated with respect to each of the plurality of satellites, whether or not each of the received signals from the plurality of satellites is normal,
calculates, based on ones of the observation data items based on ones of the received signals from the plurality of satellites, the ones of the received signals being determined to be normal, and based on the position data items, estimated reception positions at which one or more of the “N” receivers are estimated to receive the signals from the plurality of satellites, and
calculates estimated positions of a reference point in the mobile body
   based on the posture of the mobile body, the posture being estimated by the posture estimation unit, and
   based on the estimated reception positions.

A third aspect of the present disclosure relates to an apparatus that estimates a position and a posture of a mobile body. The apparatus according to the third aspect includes:

a posture estimation unit that estimates the posture of the mobile body
based on observation data items generated based on signals that “N” (N is an integer number of three or more) receivers installed in the mobile body each have received from a plurality of satellites, and
based on position data items of the plurality of satellites; and

a position estimation unit that estimates the position of the mobile body based on the observation data items and on the position data items.

The observation data items include information items about distances between the plurality of satellites and “N” reception positions at which the “N” receivers receive the signals from the plurality of satellites.

The position estimation unit
calculates, based on the position data items and on the observation data items, estimated reception positions at which one or more of the “N” receivers are estimated to receive the signals from the plurality of satellites, and
calculates estimated positions of a reference point in the mobile body
   based on the posture of the mobile body, the posture being estimated by the posture estimation unit, and
   based on the estimated reception positions.

The posture estimation unit
calculates, based on the observation data items and on the position data items, a plurality of baseline vectors in a plurality of pairs of the “N” receivers as a plurality observation vectors, the plurality of baseline vectors each being a vector defined by two reception positions of two receivers of the “N” receivers, and
estimates the posture of the mobile body based on the plurality of calculated observation vectors, and on a plurality of reference vectors corresponding to the plurality of calculated observation vectors, the plurality of reference vectors each being the baseline vector under a state in which the posture of the mobile body is a predetermined reference posture.

A fourth aspect of the present disclosure relates to a system that estimates a position and a posture of a mobile body. The system according to the fourth aspect includes:

“N” (N is an integer number of three or more) receivers installed in a mobile body, the “N” receivers each receiving signals that are broadcasted from a plurality of satellites, and each generating, based on the received signals, observation data items including information items about distances from the plurality of satellites; and

the apparatus according to any one of the first aspect, the second aspect, and the third aspect.

A fifth aspect of the present disclosure relates to a method of estimating a position and a posture of a mobile body. The method according to the fifth aspect includes:

estimating the posture of the mobile body
based on observation data items generated based on signals that “N” (N is an integer number of three or more) receivers installed in the mobile body each have received from a plurality of satellites, and
based on position data items of the plurality of satellites; and

estimating the position of the mobile body based on the observation data items and on the position data items.

The observation data items include information items about distances from the plurality of satellites to the “N” receivers.

The estimating of the position of the mobile body includes
calculating, based on the position data items and on the observation data items, estimated reception positions at which the “N” receivers are estimated to receive the signals from the plurality of satellites,
determining, based on a determination criterion for displacements between reception positions of the “N” receivers and the estimated reception positions of the “N” receivers, whether or not each of the estimated reception positions of the “N” receivers is proper, and
calculating estimated positions of a reference point in the mobile body
   based on ones of the estimated reception positions of the “N” receivers, the ones being determined to be proper by the determination, and
   based on the estimated posture of the mobile body.

A sixth aspect of the present disclosure relates to a method of estimating a position and a posture of a mobile body. The method according to the sixth aspect includes:

estimating the posture of the mobile body
based on observation data items generated based on signals that “N” (N is an integer number of three or more) receivers installed in the mobile body each have received from a plurality of satellites, and
based on position data items of the plurality of satellites; and

estimating the position of the mobile body based on the observation data items and on the position data items.

The observation data items include
information items about distances from the plurality of satellites to the “N” receivers, and
information items about signal-to-noise ratios of received signals from the plurality of satellites.

The estimating of the position of the mobile body includes
calculating, based on the observation data items including the information items about the signal-to-noise ratios, a score indicating a degree of a variation of the signal-to-noise ratios of the received signals at a same time point and from a same one of the plurality of satellites among the “N” receivers, the score being calculated with respect to each of the plurality of satellites,
determining, based on the score calculated with respect to each of the plurality of satellites, whether or not each of the received signals from the plurality of satellites is normal,
calculating, based on ones of the observation data items based on ones of the received signals from the plurality of satellites, the ones of the received signals being determined to be normal, and based on the position data items, estimated reception positions at which one or more of the “N” receivers are estimated to receive the signals from the plurality of satellites, and
calculating, based on the estimated posture of the mobile body and on the estimated reception positions, estimated positions of a reference point in the mobile body.

A seventh aspect of the present disclosure relates to a method of estimating a position and a posture of a mobile body. The method according to the seventh aspect includes:

estimating the posture of the mobile body
based on observation data items generated based on signals that “N” (N is an integer number of three or more) receivers installed in the mobile body each have received from a plurality of satellites, and
based on position data items of the plurality of satellites; and

estimating the position of the mobile body based on the observation data items and on the position data items.

The observation data items include information items about distances from the plurality of satellites to the “N” receivers.

The estimating of the position of the mobile body includes
calculating, based on the position data items and on the observation data items, estimated reception positions at which one or more of the “N” receivers are estimated to receive the signals from the plurality of satellites, and
calculating, based on the estimated posture of the mobile body and on the estimated reception positions, estimated positions of a reference point in the mobile body.

The estimating of the posture of the mobile body includes
calculating, based on the observation data items and on the position data items, a plurality of baseline vectors in a plurality of pairs of the “N” receivers as a plurality of observation vectors, the baseline vectors each being a vector defined by two reception positions of two receivers of the “N” receivers, and
estimating the posture of the mobile body based on the plurality of calculated observation vectors, and on a plurality of reference vectors corresponding to the plurality of calculated observation vectors, the plurality of reference vectors each being the baseline vector under a state in which the posture of the mobile body is a predetermined reference posture.

### Advantageous Effects of Invention

According to the aspects of the present disclosure, it is possible to provide an apparatus and a program that enable estimation of a position and a posture of a low-cost mobile body with high accuracy with use of observation data items that are acquired by the low-cost mobile body. In addition, according to the aspects of the present disclosure, it is also possible to provide a system and a method that enable the estimation of the position and the posture of the low-cost mobile body with high accuracy.

### BRIEF DESCRIPTION OF DRAWINGS

FIG. 1 is a diagram showing an example of a configuration of a system according to an embodiment of the present disclosure.

FIG. 2A and FIG. 2B are views illustrating an example of a UAV.

FIG. 3 is a diagram showing an example of a configuration of an information collection apparatus installed in the UAV.

FIG. 4 is a diagram showing an example of a configuration of an information processing apparatus.

FIG. 5 is an explanatory flowchart showing operations of generating a three-dimensional map by collecting information items with use of the information collection apparatus installed in the UAV.

FIG. 6 is a first explanatory flowchart showing a posture estimation procedure.

FIG. 7 is a second explanatory flowchart showing the posture estimation procedure.

FIG. 8A and FIG. 8B are diagrams showing thirty baseline vectors (observation vectors and reference vectors) between six reception positions.

FIG. 9 is a first explanatory flowchart showing a position estimation procedure.

FIG. 10 is a second explanatory flowchart showing the position estimation procedure.

FIG. 11 is a third explanatory flowchart showing the position estimation procedure.

FIG. 12 is a diagram showing displacements of estimated reception positions with respect to target positions.

FIG. 13 is a table showing an example of results of determinations as to whether or not each of the estimated reception positions is proper.

FIG. 14 is an explanatory flowchart showing an example of a process of selecting available ones of satellites based on an SNR variation.

### DESCRIPTION OF EMBODIMENTS

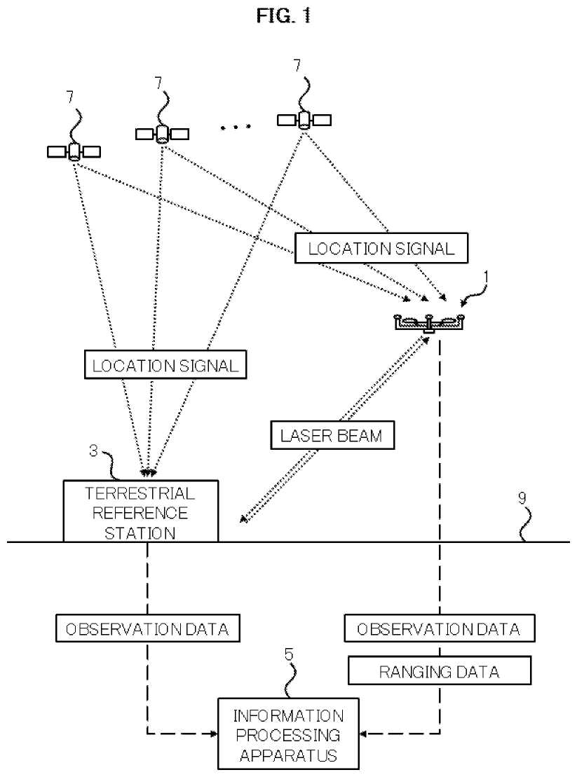

FIG. 1 is a diagram showing an example of a configuration of a system according to an embodiment of the present disclosure. In the system according to this embodiment, a UAV (unmanned aerial vehicle) 1 as a mobile body periodically receives location signals that are broadcasted from a plurality of satellites 7. With this, a position and a posture of the UAV 1 are estimated, and a distance and a direction from the UAV 1 to a ground surface 9 are measured in synchronization with reception timings of the signals. This system collects results of the estimation of the position and the posture of the UAV 1, and results of the measurement of the distance and the direction from the UAV 1 to the ground surface 9. With this, this system generates a three-dimensional map of the ground surface 9.

The system shown in the example of FIG. 1 includes an information processing apparatus 5. The information processing apparatus 5 receives an observation data item and a ranging data item that are acquired by the UAV 1 that flies in the air, and an observation data item that is acquired by a terrestrial reference station 3 installed on the ground, and processes these data items. In this way, the information processing apparatus 5 generates the three-dimensional map of the ground surface 9.

The observation data items that are acquired by the UAV 1 and the terrestrial reference station 3 are data items to be generated based on the location signals that are broadcasted from the plurality of satellites 7. The observation data items include information items about distances from the plurality of satellites 7 (distances from the plurality of satellites 7 to antennas). As described below, the UAV 1 includes a plurality of receivers, and hence the observation data item that is acquired by the UAV 1 includes observation data items generated by the plurality of receivers. Further, the ranging data item that is acquired by the UAV 1 includes a measured value of the distance from the UAV 1 to the ground surface 9, and an information item about the measurement direction as viewed from the UAV 1 at the time of measuring the distance. The ranging data item includes the measured value of the distance, which is obtained based on a reflected light beam of a laser beam applied to the ground surface 9 as shown in FIG. 1, and an information item about an irradiation direction of the laser beam. The observation data items that are acquired by the UAV 1 and the terrestrial reference station 3, and the ranging data item that is acquired by the UAV 1 are acquired substantially at the same time point at respective predetermined intervals (at intervals of, for example, one second).

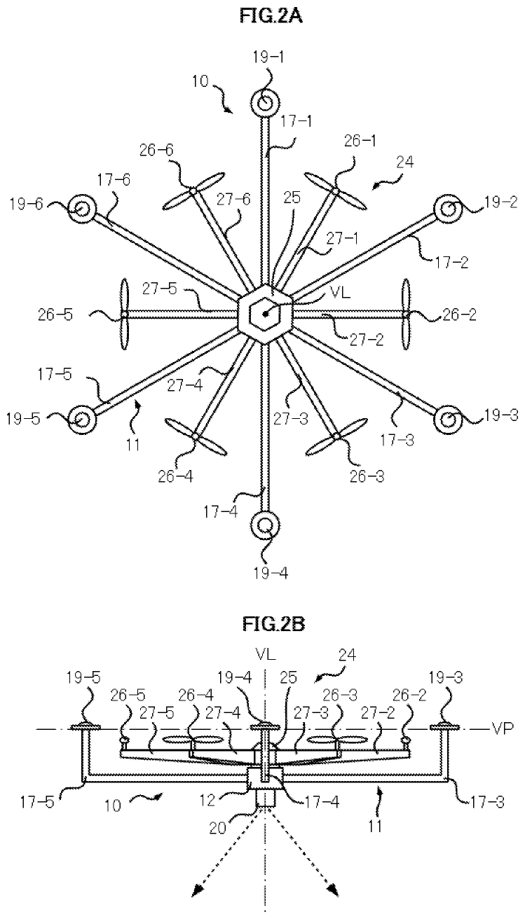

FIG. 2A and FIG. 2B are views illustrating an example of the UAV 1. FIG. 2A is a plan view, and FIG. 2B is a front view. The UAV 1 illustrated in FIG. 2A and FIG. 2B includes a propeller-type drone 24 and an information collection apparatus 10 coupled to the drone 24. The drone 24 includes a body portion 25, six arm portions 27-1 to 27-6 (below, sometimes collectively referred to as “arm portions 27”), each of which extends in a direction away from a virtual center line VL that extends through the body portion 25, and six propellers 26-1 to 26-6 (below, sometimes collectively referred to as “propellers 26”) provided respectively at one ends of the arm portions 27-1 to 27-6. As illustrated in FIG. 2A, as viewed in a direction parallel to the virtual center line VL, the six propellers 26 are arranged in an annular array and at equal intervals around the virtual center line VL.

The information collection apparatus 10 includes six antennas 19-1 to 19-6 (below, sometimes collectively referred to as “antennas 19”), each of which receives the location signals from the satellites 7, and a frame 11 to which the six antennas 19 are fixed. As illustrated in FIG. 2A, as viewed in the direction parallel to the virtual center line VL, the six antennas 19 are arranged in an annular array and at equal intervals around the virtual center line VL.

The frame 11 includes a body portion 12 and six arm portions 17-1 to 17-6 (below, sometimes collectively referred to as “arm portions 17”). The virtual center line VL extends through the body portion 12, and the six arm portions 17 each extend in a direction away from the virtual center line VL. The antennas 19 are fixed respectively to one ends of the arm portions 17, which are away from the body portion 12. In the example of FIG. 2B, the arm portions 17 each extend in a horizontal direction from the body portion 12, and are each partway bent upward in an L-shape with respect to the horizontal direction. The antennas 19, each of which has a disk shape, are fixed to respective distal ends of the upward extending parts of the arm portions 17. The six antennas 19 are located in a common virtual plane VP perpendicular to the virtual center line VL.

As illustrated in FIG. 2A, as viewed in the direction parallel to the virtual center line VL, the arm portions 17 each extend in a direction that substantially bisects an angle formed between adjacent two of the arm portions 27. The six antennas 19 fixed to the one ends of the arm portions 17 are farther from the virtual center line VL than the propellers 26 of the drone 24 are, and located above the propellers 26. The body portion 12 of the information collection apparatus 10 is coupled to a bottom surface of the body portion 25 of the drone 24. The information collection apparatus 10 is suspended from the drone 24, and in this state, flies together with the drone 24. A ranging apparatus 20 is attached to a bottom surface of the body portion 12 of the information collection apparatus 10, and the ranging laser beam is applied from the ranging apparatus 20 toward the ground surface 9.

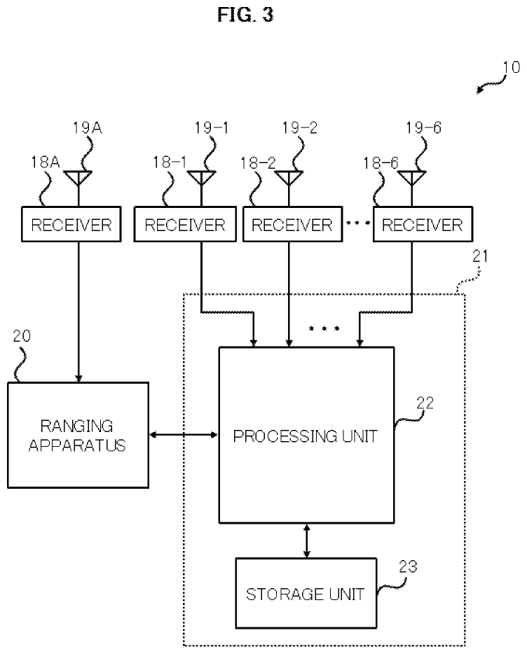

FIG. 3 is a diagram showing an example of a configuration of the information collection apparatus 10 installed in the UAV 1. The information collection apparatus 10 shown in FIG. 3 includes six receivers 18-1 to 18-6 (below, sometimes collectively referred to as “receivers 18”) that are used for estimating the position and the posture, the ranging apparatus 20, a receiver 18A that is used for setting a measurement timing of the ranging apparatus 20, and a control apparatus 21.

The receivers 18 receive, via the antennas 19, the signals that are broadcasted from the satellites 7. The receivers 18 receive the location signals that are broadcasted from the plurality of satellites 7, and generate, based on these received signals, the observation data items including the information items about the distances between the plurality of satellites 7 and reception positions of the antennas 19, at which the location signals are received. The observation data items include information items about carrier phases of the signals broadcasted from the plurality of satellites 7. The receivers 18 periodically receive the signals from the satellites 7 (at the intervals of, for example, one second) at timings in synchronization with system clocks precisely controlled in the satellites 7, and generate the observation data items.

The receiver 18A receives, via an antenna 19A, the signals that are broadcasted from the satellites 7. The receiver 18A outputs, in response to the received signals from the satellites 7, signals that signify the periodical reception timings in synchronization with the above-mentioned system clocks to the ranging apparatus 20.

The ranging apparatus 20, which is located at a reference point for the estimation of the position of the UAV 1, measures a distance from the reference point to a target. The ranging apparatus 20, which is, for example, a laser scanner, measures the distance between one point on the ground surface 9 and the reference point based, for example, on a phase and a time interval of the reflected light beam of the laser beam applied to the one point on the ground surface 9. The ranging apparatus 20 scans the ground surface 9 with the laser beams so as to measure distances to a large number of positions on the ground surface 9. Based on the signals that are output from the receiver 18A, which signify the reception timings, the ranging apparatus 20 measures the distances at the timings in synchronization with the reception of the signals from the satellites 7 by the six receivers 18. The ranging apparatus 20 generates the ranging data items including the measured values of the distances, and the information items about the measurement directions (irradiation directions of the laser beams).

The control apparatus 21 records the observation data items generated by the receivers 18-1 to 18-6, and the ranging data items generated by the ranging apparatus 20. In the example of FIG. 3, the control apparatus 21 includes a processing unit 22 and a storage unit 23. The processing unit 22 correlates ones of the observation data items obtained by the six receivers 18-1 to 18-6, and one of the ranging data items obtained by the ranging apparatus 20 to each other, the ones of these data items being obtained at the same time point, and records these data items to the storage unit 23. In this way, sets of the observation data items and the ranging data items obtained at the same time points are accumulated in an order of the time points in the storage unit 23.

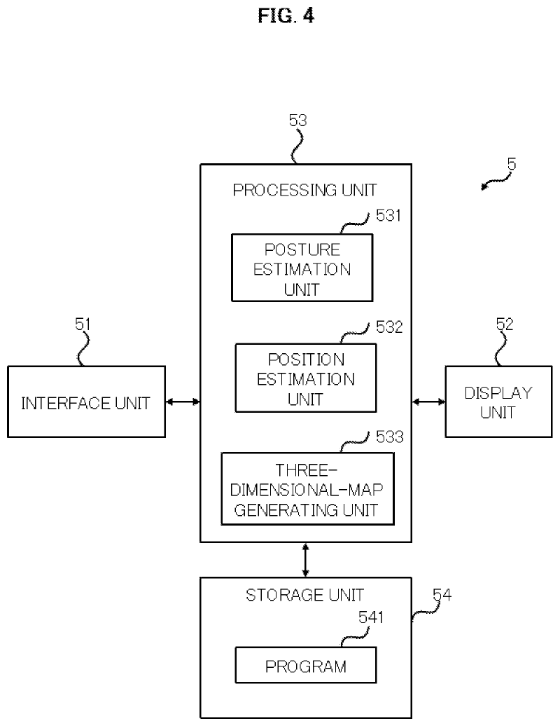

FIG. 4 is a diagram showing an example of a configuration of the information processing apparatus 5. The information processing apparatus 5 shown in FIG. 4 includes an interface unit 51, a display unit 52, a processing unit 53, and a storage unit 54.

The interface unit 51 includes user interface devices (such as a keyboard, a mouse, a touchpad, and a touchscreen) for allowing information items in response to operations by a user to be input to the processing unit 53. Further, the interface unit 51 also includes a communication interface for exchanging the information items between external devices and the processing unit 53, general-purpose input/output interfaces such as a USB, and a recording-medium reading apparatus.

The display unit 52, which is an apparatus that displays videos under control by the processing unit 53, includes a display apparatus (such as liquid-crystal display or OLED display).

The processing unit 53, which is an apparatus that executes various information processes, includes a computer that executes processes in accordance with instruction codes of a program 541 that is stored in the storage unit 54. The processing unit 53 may execute at least some of the processes with dedicated hardware.

In the example of FIG. 4, the processing unit 53 includes a posture estimation unit 531, a position estimation unit 532, and a three-dimensional-map generating unit 533. The processing unit 53 receives, via the interface unit 51, the data items (observation data items and ranging data items) accumulated in the storage unit 23 of the information collection apparatus 10 (FIG. 3), and uses these data items for processes in the units therein (the posture estimation unit 531, the position estimation unit 532, and the three-dimensional-map generating unit 533).

The posture estimation unit 531 estimates the posture of the UAV 1 based on the observation data items generated based on the signals that the six receivers 18 installed in the UAV 1 have received from the plurality of satellites 7, and based on position data items of the plurality of satellites 7. The position data items, which are data items including information items about positions of the satellites 7 at each time point, which move in their predetermined respective orbits, are acquired based on published known information items.

The position estimation unit 532 estimates, based on the observation data items and the position data items described above, a position of the reference point in the UAV 1. Specifically, the position estimation unit 532 calculates, based on the position data items and the observation data items, “estimated reception positions PE” at which the one or more receivers 18 are estimated to receive the signals from the satellites 7 via the antennas 19. The position estimation unit 532 calculates an estimated position PX of the reference point in the UAV 1 based on the posture of the UAV 1, which is estimated by the posture estimation unit 531, and on the calculated one or more estimated reception positions PE.

The three-dimensional-map generating unit 533 acquires, at each of the time points, the posture of the UAV 1, which is estimated by the posture estimation unit 531, the estimated position PX of the reference point, which is estimated by the position estimation unit 532, the distance measured value of the ranging apparatus 20, and the information item about the irradiation direction of the laser beam from the ranging apparatus 20. Based on these data items acquired at each of the time points, the three-dimensional-map generating unit 533 calculates three-dimensional coordinates of each of the positions on the ground surface 9.

The storage unit 54 stores, for example, the program 541 that is executed by the computer of the processing unit 53, data items that are temporarily stored in the course of the processes by the processing unit 53, and constants that are utilized in the processes by the processing unit 53. The storage unit 54 includes one or more arbitrary storage apparatus such as a ROM, a RAM, a flash memory, a hard disk, and a magnetic recording medium.

Next, operations in the system having the above-described configuration is described.

(Overall Operation)

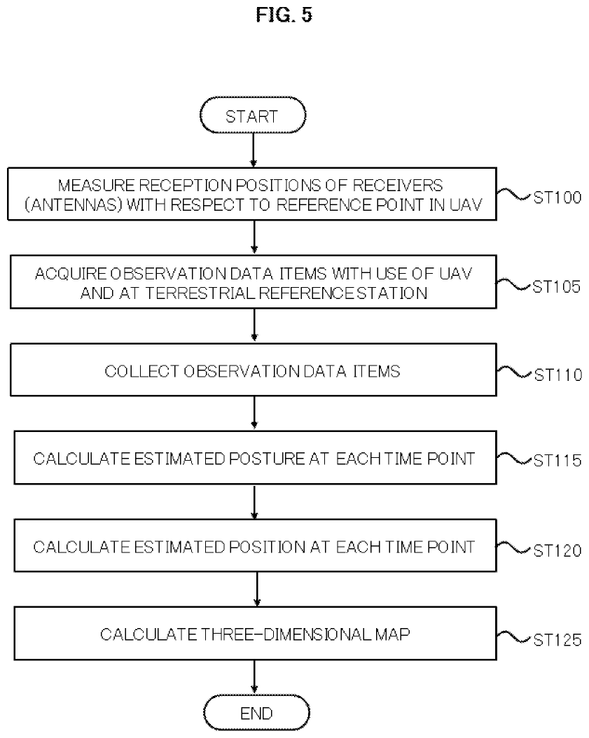

FIG. 5 is an explanatory flowchart showing operations of generating the three-dimensional map by collecting the information items with use of the information collection apparatus 10 installed in the UAV 1.

First, the reception positions at which the receivers 18 of the UAV 1 receive the signals from the satellites 7 (reception positions of the antennas 19, at which the signals are received) are measured (ST100). The reception positions of the receivers 18 are precisely measured as relative positions with respect to the reference point (laser-beam emitting position of the ranging apparatus 20). The reception positions of the receivers 18 are used not only as references at the time of calculating the estimated posture, but also for determining whether or not the estimated position calculated based on the observation data items is proper.

Then, the UAV 1 is flown, and the information collection apparatus 10 installed in the UAV 1 collects the information items (ST105). Specifically, the information collection apparatus 10 performs, periodically and at the same timings, the signal reception by the six receivers 18, and the distance measurement by the ranging apparatus 20. The information collection apparatus 10 accumulates, as data items in time series, the sets of the observation data items and the ranging data items obtained at the same timings.

Further, while the information collection apparatus 10 of the UAV 1 collects the information items, the terrestrial reference station 3 (FIG. 1) also receives the signals from the satellites 7. The terrestrial reference station 3 may be installed by a public institution, or may be installed by the user himself/herself. The terrestrial reference station 3 receives the signals from the satellites 7 at a place from which the position have been precisely measured in advance, and generates the observation data items including the information items about the distances to the satellites 7.

After desired information items are collected by the information collection apparatus 10, the information items (observation data items and ranging data items) collected by the information collection apparatus 10 are collected, and then input to the information processing apparatus 5. Further, the observation data items obtained by the terrestrial reference station 3, and the position data items indicating the positions of the satellites 7 at each of the time points are also input to the information processing apparatus 5 (ST110).

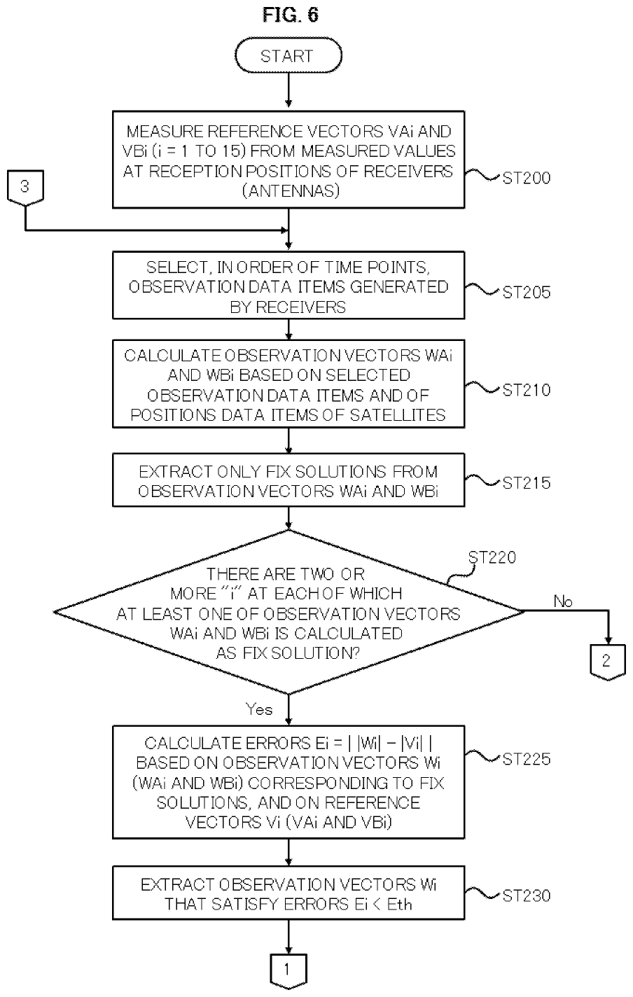

Based on the observation data items generated by the six receivers 18 and collected by the information collection apparatus 10, and on the position data items of the satellites 7, the posture estimation unit 531 of the information processing apparatus 5 calculates the estimated posture of the UAV 1 at each of the time points (ST115). Details of a procedure for calculating the estimated posture are described below with reference to FIG. 6 to FIG. 8.

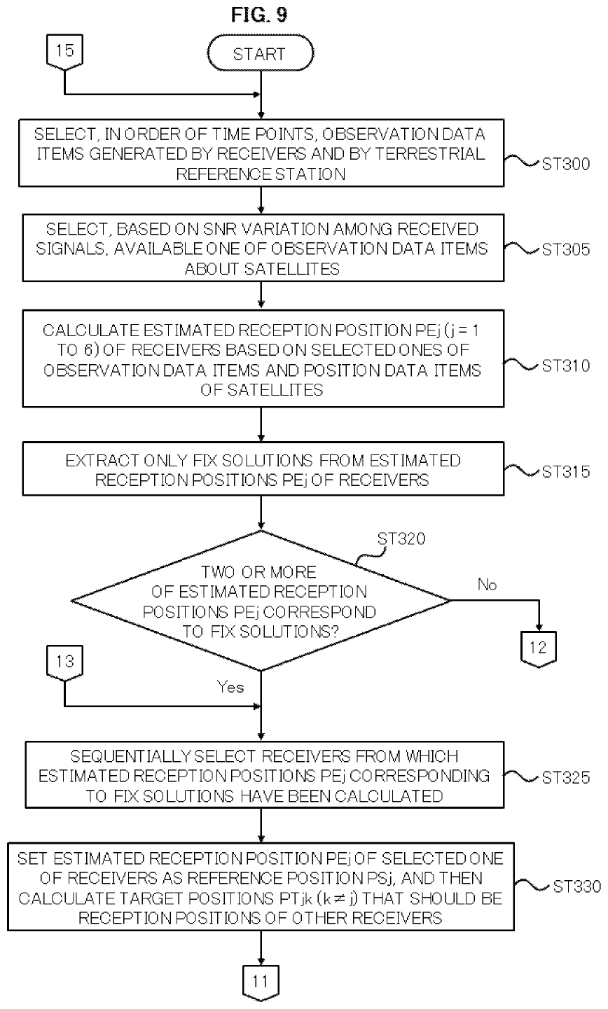

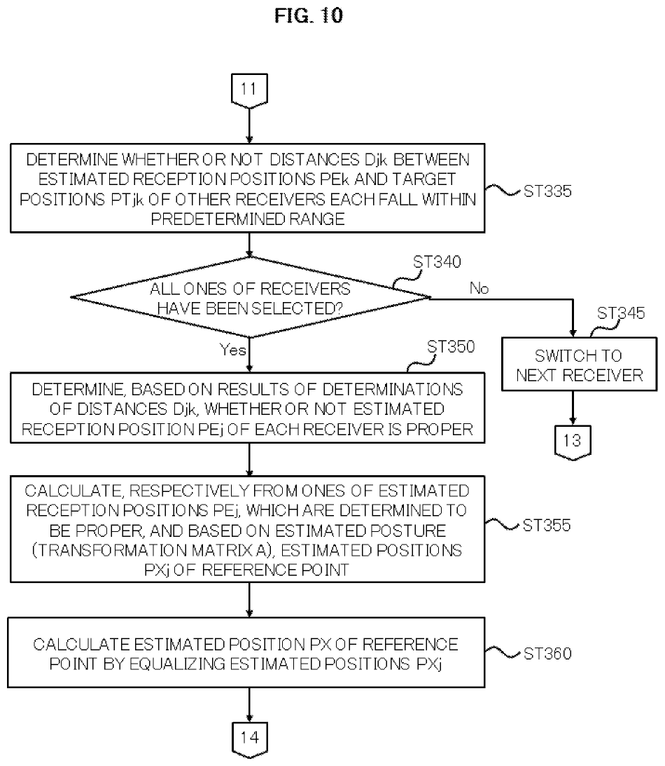

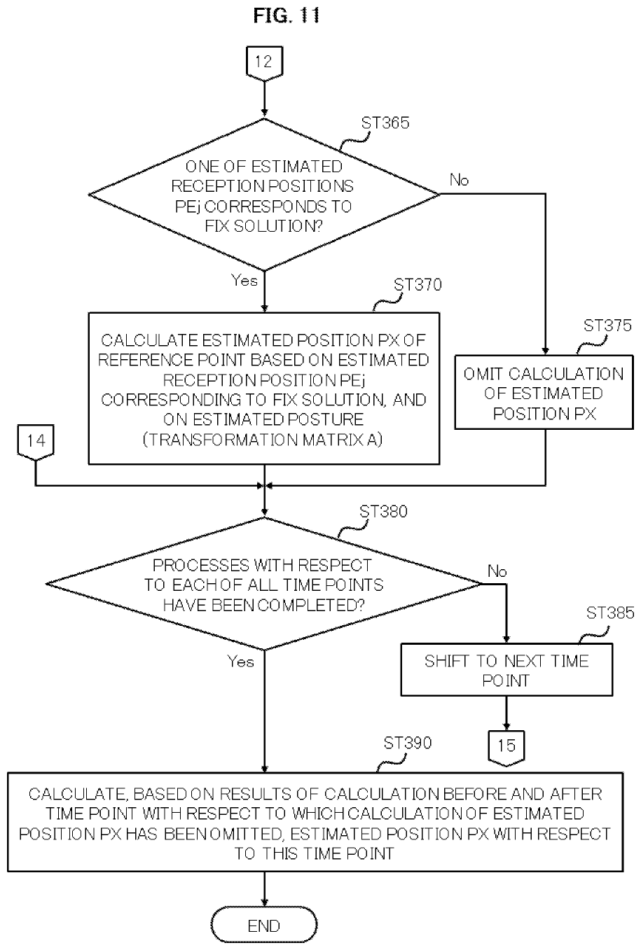

Next, based on the observation data items generated by the six receivers 18 and collected by the information collection apparatus 10, on the position data items of the satellites 7, on the observation data items obtained by the terrestrial reference station 3, and on the already-calculated estimated posture of the UAV 1, the position estimation unit 532 of the information processing apparatus 5 calculates the estimated position PX of the reference point in the UAV 1 (ST120). Details of a procedure for calculating the estimated position PX of the reference point are described below with reference to FIG. 9 to FIG. 14.

Based on the estimated posture of the UAV 1, on the estimated position PX of the reference point, and on the ranging data item (measured value of the distance and irradiation direction of the laser beam) at the same time point, the three-dimensional-map generating unit 533 of the information processing apparatus 5 calculates three-dimensional coordinates of one point on the ground surface 9. By collecting the three-dimensional coordinates on the ground surface 9, which are calculated at each of the time points, a three-dimensional data item (three-dimensional map) within a certain range on the ground surface 9 is obtained (ST125).

(Posture Estimation Procedure)

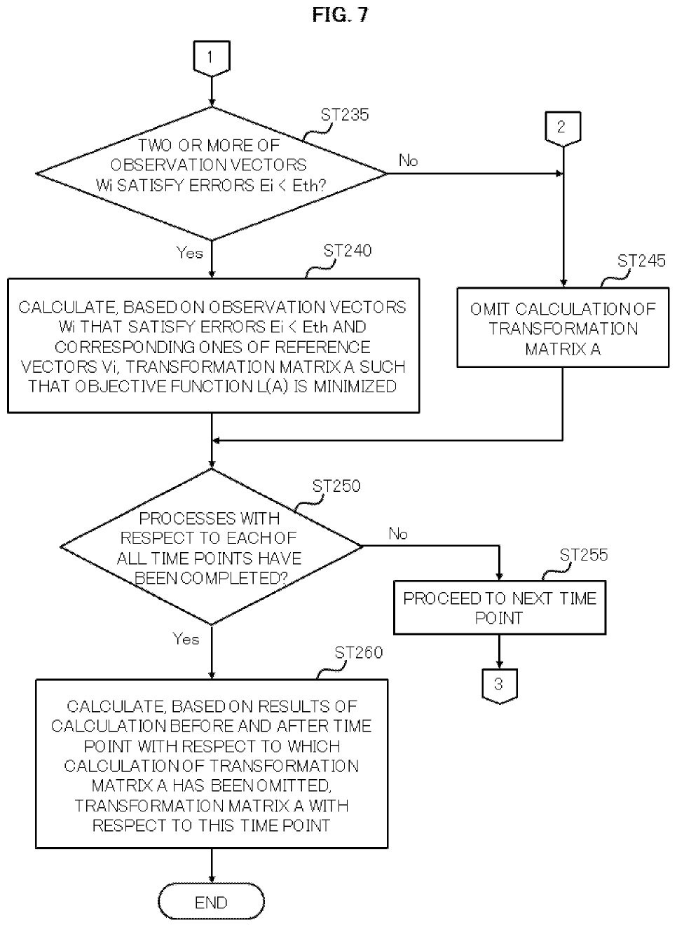

FIG. 6 and FIG. 7 are explanatory flowcharts showing the posture estimation procedure by the posture estimation unit 531 of the information processing apparatus 5.

First, based on the reception positions of the antennas 19 of the receivers 18, which are measured in Step ST100 (FIG. 5), the posture estimation unit 531 calculates reference vectors VA1 to VA15 and VB1 to VB15 (ST200).

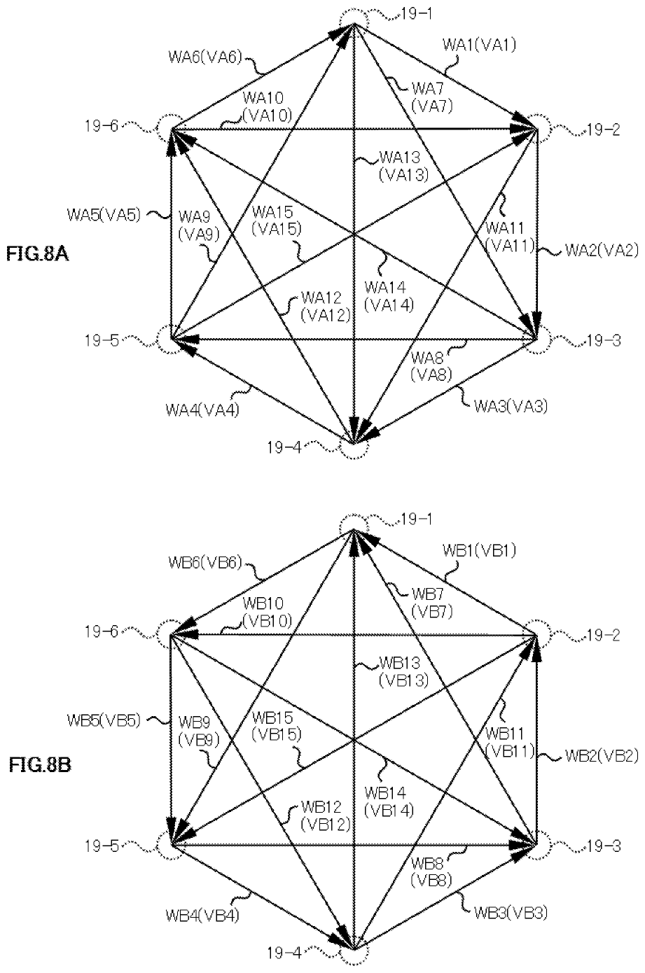

FIG. 8A and FIG. 8B are diagrams showing thirty baseline vectors (observation vectors and the reference vectors) between the six reception positions. The “baseline vectors” herein refer to vectors each defined by two of the reception positions (positions at which the signals from the satellites 7 are received by the antennas 19 of the receivers 18). The baseline vectors are each a vector between one of the two of the reception positions as a start point and another one of the two as an end point. Two of the baseline vectors, which are opposite to each other, exist in a pair of the receivers 18. The six receivers 18 are paired into fifteen pairs, and hence the thirty baseline vectors exist in total.

The “reference vectors” refer to ones of the baseline vectors under a state in which the posture of the UAV 1 is a predetermined reference posture, which are denoted by the reference symbols “VAi” or “VBi” in FIG. 8A and FIG. 8B. Note that, “i” is an integer number of from “1” to “15.” When the reference vector VAi and the reference vector VBi have the same numeral, these reference vectors are two baseline vectors for one pair of the pairs of the receivers 18, and are opposite to each other. Below, the reference vectors VAi and VBi are sometimes collectively referred to as “reference vectors V”.

For example, the posture estimation unit 531 transforms coordinates of the reception positions of the antennas 19 (coordinates with respect to the reference point as an origin), which are measured in Step ST100 (FIG. 5), into coordinates in an earth-centered, earth-fixed (ECEF) coordinate system. With this, the posture estimation unit 531 determines the reference posture of the UAV 1 with respect to the earth-centered, earth-fixed coordinate system. Note that, when the coordinates of the reception positions of the antennas 19, which are measured in Step ST100 (FIG. 5), are regarded as the coordinates in the earth-centered, earth-fixed coordinate system, the process of Step ST200 may be omitted. The reference vectors VA1 to VA15 and VB1 to VB15 are specified respectively from the reception positions of the antennas 19, which are represented as the coordinates in the earth-centered, earth-fixed coordinate system.

Next, the posture estimation unit 531 selects, in the order of the time points, the observation data items generated by the receivers 18 that are subjected to the posture estimation, and acquires the position data items of the satellites 7 at these time points (ST205). After that, based on these observation data items and position data items, the posture estimation unit 531 calculates observation vectors WA1 to WA15 and WB1 to WB15 (ST210).

The “observation vectors” refer to other ones of the baseline vectors, which are estimated based on the observation data items and the position data items, and are denoted by reference symbols “WAi” or “WBi” in FIG. 8A and FIG. 8B. When the observation vector WAi and the observation vector WBi have the same numeral, these observation vectors are two baseline vectors for one pair of the pairs of the receivers 18, and are opposite to each other. Below, the observation vectors WAi and WBi are sometimes collectively referred to as “observation vectors W.”

For example, when the posture estimation unit 531 calculates the baselines vectors defined by the reception positions of two of the receivers 18 as the observation vectors W, the posture estimation unit 531 uses an interferometric positioning technique including using the carrier phases of the signals received from the satellites 7. In this case, based on a carrier phase of a signal that is received by one of the receivers 18, and on a carrier phase of a signal that is received by another one of the receivers 18, the posture estimation unit 531 calculates a correlation between the reception position of the one of the receivers 18 and the reception position of the other one of the receivers 18 as the observation vectors W. By using the interferometric positioning technique, even when general-purpose single-frequency GNSS receivers are used as the receiver 18, the relative positional relationship between the two reception positions can be estimated with high accuracy.

When the posture estimation unit 531 calculates the observation vectors W by the interferometric positioning technique, the posture estimation unit 531 executes an arithmetic process for calculating integer ambiguities with respect to the carrier phases of the signals received by the two of the receivers 18 (specifically, integer ambiguities of a carrier-phase double difference). With this, the posture estimation unit 531 calculates a high-accuracy observation vector W obtained when the integer ambiguity is solved as an integer solution, or a low-accuracy observation vector W obtained when the integer ambiguity is solved as a non-integer solution. Below, an arithmetic result when the integer ambiguity is solved as an integer solution may sometimes be referred to as a “FIX solution,” and an arithmetic result when the integer ambiguity is solved as a non-integer solution may sometimes be referred to as a “FLOAT solution.”

The posture estimation unit 531 extracts only ones of the observation vectors W, which have the FIX solutions, from the calculated thirty observation vectors WA1 to WA15 and WB1 to WB15 (ST215).

The posture estimation unit 531 determines whether or not there are two or more integer values “i” at each of which at least one of the two observation vectors WAi and WBi opposite to each other is calculated as the FIX solution (ST220). In other words, the posture estimation unit 531 determines whether or not two or more of the observation vectors W, which correspond to the FIX solutions, are calculated from two or more of the pairs of the receivers 18.

When the two or more of the observation vectors W, which correspond to the FIX solutions, are calculated from the two or more of the pairs of the receivers 18 (Yes in ST220), the posture estimation unit 531 determines whether or not an error between a length of each of the calculated observation vectors W corresponding to the FIX solutions, and a length of each of the reference vectors V, which corresponds to corresponding one of the calculated observation vectors W, falls within a predetermined range (ST225).

Specifically, the posture estimation unit 531 calculates errors Ei=∥Wi|−|Vi∥ based on observation vectors Wi each corresponding to the FIX solution, and on reference vectors Vi corresponding respectively to the observation vectors Wi. The posture estimation unit 531 determines whether or not the error Ei calculated from each of the observation vectors Wi is less than a predetermined threshold Eth.

The posture estimation unit 531 extracts, based on results of the determination of the errors Ei, ones of the observation vectors Wi from the observation vectors Wi corresponding to the FIX solutions, the errors Ei of the ones each being less than the threshold Eth (ST230). Then, the posture estimation unit 531 determines whether or not the number of the extracted observation vectors Wi is two or more (ST235).

When the two or more of the observation vectors Wi, which satisfy the errors Ei<Eth, are extracted (Yes in ST235), the posture estimation unit 531 estimates the posture of the UAV 1 based on the extracted two or more of the observation vectors Wi and corresponding two or more of the reference vectors Vi (ST240).

Specifically, the posture estimation unit 531 calculates a transformation matrix A that defines transformations between the two or more of the reference vectors Vi and the two or more of the observation vectors Wi, which correspond one by one to each other, such that a predetermined objective function L(A) is minimized.

The observation vectors Wi and the reference vectors Vi are expressed as the transformation matrix A by the following equation.

[Math. 1]

Wi=A*Vi (1)

The objective function L(A) is expressed, for example, by the following equations.

[Math. 2]

L(A)=½Σ{αi*|Wi−A*Vi|²} (2-1)

Σαi=1 (2-2)

The term |Wi−A*Vi|² in the equation (2-1) has a value in accordance with a difference between a vector obtained by transforming the reference vector Vi by the transformation matrix A and the observation vector Wi (vector error). The objective function L(A) is a function in accordance with a sum of products obtained by multiplying, by weighting coefficients αi, the terms |Wi−A*Vi|² of all ones of the observation vectors Wi, which are extracted in Step ST230.

The weighting coefficients αi each have a value in proportion to the length of the reference vector Vi, and a sum of the weighting coefficients αi is one as expressed by the equation (2-2). As the reference vector Vi becomes longer, an error of the posture with respect to errors of installation positions of the antennas 19 becomes smaller. Thus, when the weighting coefficients αi by which the terms |Wi−A*Vi|² are multiplied are increased in proportion to the lengths of the reference vectors Vi, a possibility that the transformation matrix A having the small posture error is calculated increases. After the posture estimation unit 531 calculates the transformation matrix A in Step ST240, the posture estimation unit 531 advances the procedure to Step ST250.

Note that, when one or less of the observation vectors W correspond to the FIX solutions, or when the observation vectors W corresponding to the FIX solutions are only two of the observation vectors W, which are opposite to each other in one of the pairs of the receivers 18 (No in ST220), the posture estimation unit 531 advances the procedure to Step ST250 without performing the calculation of the transformation matrix A in Step ST240 (ST245). Further, also when one or less of the observation vectors Wi satisfy the errors Ei<Eth (No in ST235), the posture estimation unit 531 advances the procedure to Step ST250 by skipping Step ST240.

After the posture estimation unit 531 advances the procedure to Step ST250, the posture estimation unit 531 checks whether the process of calculating the transformation matrix A with respect to each of all the time points has been completed. When there is any time point with respect to which the calculation process has not been executed (No in ST250), the posture estimation unit 531 proceeds to a next time point (ST255), and repeats the process of Step ST205 and the subsequent processes. After these processes with respect to each of all the time points have been completed (Yes in ST250), the posture estimation unit 531 advances the procedure to Step ST260.

In Step ST260, the posture estimation unit 531 specifies a time point with respect to which the calculation of the transformation matrix A has been omitted, and calculates the transformation matrix A with respect to this time point based on results of calculation of transformation matrices A before and after this time point. Specifically, the posture estimation unit 531 calculates, by using, for example, a spherical linear interpolation technique, a transformation matrix A with respect to an intermediate time point from the two transformation matrices A calculated with respect to the preceding and the subsequent time points.

(Position Estimation Procedure)

FIG. 9 to FIG. 11 are explanatory flowcharts showing the position estimation procedure by the position estimation unit 532 of the information processing apparatus 5.

The position estimation unit 532 selects, in the order of the time points, the observation data items generated by the receivers 18 that are subjected to the position estimation. Further, the position estimation unit 532 acquires, in addition to the position data items of the satellites 7, which are used in the posture estimation procedure, the observation data items obtained by the terrestrial reference station 3 at these time points (ST300).

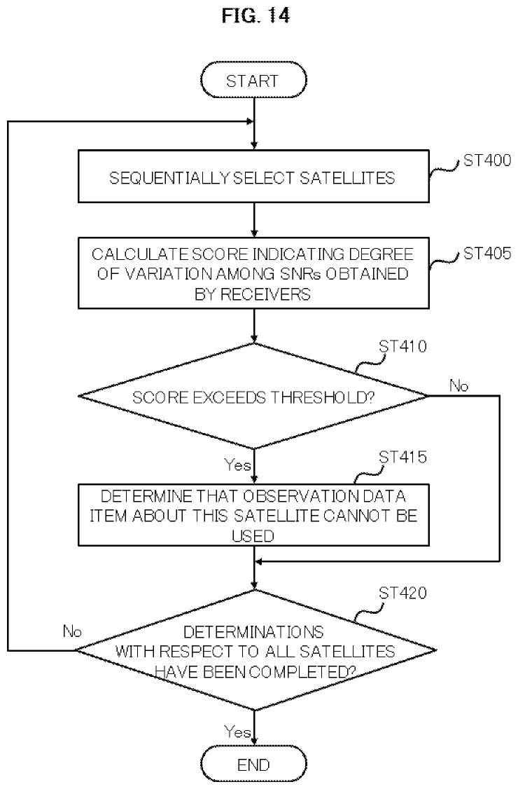

In order to estimate the positions, first, the position estimation unit 532 evaluates a degree of an SNR (signal-to-noise ratio) variation among the received signals from each of the satellites 7, which are received by the six receivers 18 at the same time point. Based on results of the evaluations, the position estimation unit 532 selects available ones of the observation data items about each of the satellites 7 (ST305). Processes regarding the evaluation of the degree of the SNR variation are described below with reference to FIG. 14.

Then, based on the ones of the observation data items about each of the satellites 7, which are selected in Step ST305, on the observation data items about each of the satellites 7, which are obtained by the terrestrial reference station 3, and on the position data items of the satellites 7, the position estimation unit 532 calculates the reception positions at which the six receivers 18 are estimated to receive the signals from the satellites 7 (estimated reception positions PE) (ST310). Below, estimated reception positions of receivers 18-j (“j” is an integer number of from “1” to “6”) are denoted by “PEj.”

The position estimation unit 532 calculates, by the interferometric positioning, relative positional relationships between a reception position in the terrestrial reference station 3, at which the signals from the satellites 7 are received, and the estimated reception positions PEj of the receivers 18-j. The reception position in the terrestrial reference station 3 has already been known, and hence the position estimation unit 532 is allowed to calculate the estimated reception positions PEj of the receivers 18-j by the interferometric positioning. In this case, as in the posture estimation procedure for calculating the observation vectors W, the position estimation unit 532 executes an arithmetic process for calculating integer ambiguities with respect to carrier phases of the observation data items obtained by the terrestrial reference station 3, and with respect to carrier phases of observation data items generated by the receivers 18-j (specifically, integer ambiguities of a carrier-phase double difference). With this, the position estimation unit 532 calculates the estimated reception positions PEj, which correspond to the FIX solutions or the FLOAT solutions.

The position estimation unit 532 extracts only ones of the estimated reception positions PEj, which correspond to the FIX solutions, from the six estimated reception positions PEj calculated with respect to the six receivers 18 (ST315).

When two or more of the estimated reception positions PEj correspond to the FIX solutions (Yes in ST320), the position estimation unit 532 executes the following determination procedure of Steps ST325 to ST335 with respect to the estimated reception positions PEj corresponding to the FIX solutions. When one or less of the estimated reception positions PEj correspond to the FIX solutions (No in ST320), the position estimation unit 532 advances the procedure to Step ST365.

In the determination procedure of Steps ST325 to ST335, based on a determination criterion for displacements between the reception positions of the plurality of receivers 18 (already-known reception positions measured in Step ST100), and the plurality of estimated reception positions PEj, the position estimation unit 532 determines whether or not each of the estimated reception positions PEj corresponding to the FIX solutions is proper.

Specifically, the position estimation unit 532 sequentially selects two or more of the receivers 18, from which the estimated reception positions PEj corresponding to the FIX solutions have been calculated (ST325). Then, when one of the estimated reception position PEj of a selected one of the receivers 18-j is set as a reference position PSj, the position estimation unit 532 calculates target positions PTjk that should be reception positions of other receivers 18-k (k≠j). Based on the posture of the UAV 1 (transformation matrix A), which has already been estimated by the posture estimation unit 531, and on the reference position PSj, the position estimation unit 532 calculates the target positions PTjk (ST330). Relative positional relationships between the reception positions of the receivers 18 remain constant even when the position and the posture of the UAV 1 have varied. Once the estimated reception position PEj (reference position PSj) of any one of the receivers 18-j and the posture of the UAV 1 have been calculated, the target positions PTjk of the other receivers 18-k can be calculated. The position estimation unit 532 determines whether or not distances Djk between estimated reception positions PEk and the target positions PTjk of the other receivers 18-k each fall within a predetermined range (ST335).

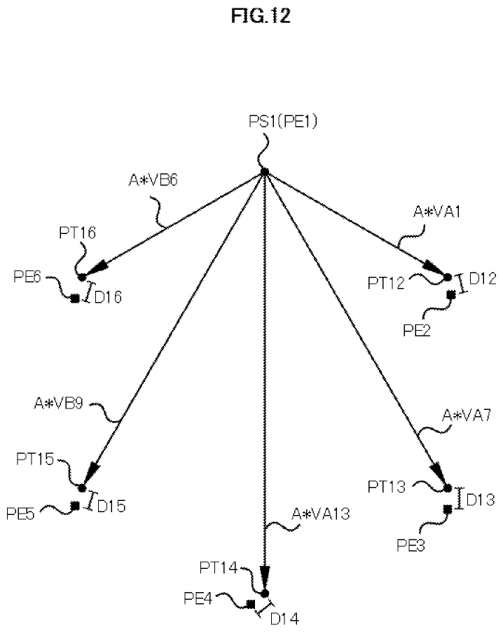

FIG. 12 is a diagram showing displacements of the estimated reception positions PEk with respect to the target positions PTjk. In the example of FIG. 12, distances D12 to D16 between estimated reception positions PE2 to PE6 and target positions PT12 to PT16 of the other receivers 18-2 to 18-6 at a time when an estimated reception position PE1 of the receiver 18-1 is set as a reference position PS1 are shown. The target positions PTjk with respect to the reference position PSj can be calculated by the transformation of the reference vectors V extending from the reference position PSj as shown in FIG. 12 by the transformation matrix A.

The position estimation unit 532 executes the determination procedures of Steps ST325 to ST335 with respect to ones of the receivers 18, from all of which the FIX solutions have been obtained (ST340 and ST345).

After the position estimation unit 532 obtains results of the determination procedures (ST325 to ST335) with respect to the ones of the receivers 18, from all of which the FIX solutions have been obtained, the position estimation unit 532 determines, based on these determination results, whether or not each of the estimated reception positions PEj corresponding to the FIX solutions is proper (ST350).

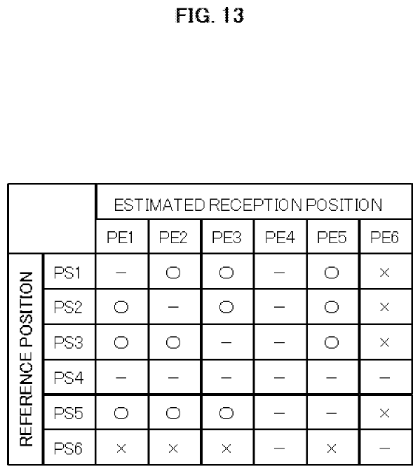

FIG. 13 is a table showing an example of the results of the determination procedure of Steps ST325 to ST335 as to whether or not each of the estimated reception positions PEj is proper. “O”-marks each indicate a case where the distance Djk falls within the predetermined range, and “X”-marks each indicate a case where the distance Djk has deviated from the predetermined range. In the example shown in FIG. 13, an estimated reception position PE4 of the receiver 18-4 is calculated as the FLOAT solution, and hence the determination procedure of Steps ST325 to ST335 is not executed thereon. For example, the position estimation unit 532 determines that one of the estimated reception positions PEj, from which determinations that more than half of the distances Djk have not fall within the predetermined range are obtained as a result of the determination procedure, is improper. Specifically, in the example of FIG. 13, all the results of the determination procedure with respect to the estimated reception position PE6 are indicated by the “X”-marks, and hence the position estimation unit 532 determines that the estimated reception position PE6 is improper.

Note that, when it is determined, by the determination procedure with respect to the reference position PSj, that the distances Djk of more than half of the estimated reception positions PEk have not fallen within the predetermined range, the position estimation unit 532 may determine that the estimated reception position PEj being the reference position PSj is improper.

The position estimation unit 532 calculates, respectively from ones of the estimated reception positions PEj, which are determined to be proper in Step ST350, and based on the estimated posture (transformation matrix A), estimated positions PXj of the reference point (ST355). The reception positions of the receivers 18-j with respect to the reference point have already been measured (ST100 in FIG. 5). Thus, once the estimated reception positions PEj of the receivers 18-j and the estimated posture (transformation matrix A) have been calculated, the estimated positions PXj of the reference point can be calculated.

When the position estimation unit 532 determines in Step ST350 that two or more of the estimated reception positions PEj are proper, the position estimation unit 532 calculates the final estimated position PX by equalizing two or more of the estimated positions PXj, which are calculated from these two or more of the estimated reception positions PEj (ST360). After the position estimation unit 532 calculates the estimated position PX in Step ST360, the position estimation unit 532 advances the procedure to Step ST380.

Note that, when only one of the estimated reception positions PEj is calculated as that corresponding to the FIX solution in Step ST310 (No in ST320 and Yes in ST365), the position estimation unit 532 calculates the estimated position PX of the reference point based on the only one estimated reception position PEj corresponding to the FIX solution, and on the estimated posture (transformation matrix A) (ST370). Further, when the estimated reception positions PEj corresponding to the FIX solutions are not calculated in Step ST310 (No in ST320 and No in ST365), the position estimation unit 532 omits the calculation of the estimated position PX of the reference point (ST375). After the Step ST370 or ST375, the position estimation unit 532 advances the procedure to Step ST380.

After the position estimation unit 532 advances the procedure to Step ST380, the position estimation unit 532 checks whether the process of calculating the transformation matrix A with respect to each of all the time points has been completed. When there is any time point with respect to which the process has not been executed (No in ST380), the position estimation unit 532 proceeds to a next time point (ST385), and repeats the process of Step ST300 and the subsequent processes. After these processes with respect to each of all the time points have been completed (Yes in ST380), the position estimation unit 532 advances the procedure to Step ST390.

In Step ST390, the position estimation unit 532 specifies a time point with respect to which the calculation of the estimated position PX has been omitted, and calculates the estimated position PX with respect to this time point based on results of calculation of estimated positions PX before and after this time point. Specifically, the position estimation unit 532 calculates, by using, for example, the spherical linear interpolation technique, an estimated position PX with respect to an intermediate time point from the two estimated positions PX calculated with respect to the preceding and the subsequent time points.

(Determination Procedure Based on SNR Variation)

FIG. 14 is an explanatory flowchart showing an example of the process of selecting the available ones of the satellites 7 based on the SNR variation (ST305 in FIG. 9).

The position estimation unit 532 sequentially selects ones of the plurality of satellites 7, from which the signals can be received (ST400). The position estimation unit 532 acquires six SNRs measured by the six receivers 18 with respect to a received signal from the selected one of the satellites 7, and calculates a score indicating a degree of a variation thereamong (ST405). For example, the position estimation unit 532 calculates a standard deviation of the six SNRs as the score. The position estimation unit 532 determines whether or not the calculated score exceeds a predetermined threshold (ST410). When the score exceeds the threshold, the position estimation unit 532 determines that an observation data item about this satellite 7 cannot be used (ST415). The position estimation unit 532 executes the determination procedure of Steps ST405 to ST415 with respect to all the satellites 7 (ST420).

### SUMMARY

According to this embodiment, the following advantages can be obtained.

(1) The six receivers 18 installed in the UAV 1 generate the observation data items based on the signals that the six receivers 18 have received from the plurality of satellites 7. The observation data items include the information items about the distances from the plurality of satellites 7 to the reception positions of the receivers 18. Based on these observation data items and on the position data items of the plurality of satellites 7, the posture of the UAV 1 is estimated, and the position of the UAV 1 is estimated. With this, even without installing the IMU in the UAV 1, the posture of the UAV 1 can be estimated with high accuracy by the six receivers 18. Further, even without installing high-accuracy receivers such as a dual-frequency GNSS receiver into the UAV 1, the position of the UAV 1 can be estimated with high accuracy. Thus, the posture and the position of the UAV 1 can be estimated with high accuracy with use of the observation data items that are obtained by the low-cost UAV 1.

(2) Based on the position data items and on the observation data items, the estimated reception position PEj of the one or more receivers 18 installed in the UAV 1 is calculated. Based on the calculated estimated-reception positions PEj and on the posture of the UAV 1, which is estimated by the posture estimation unit 531, the estimated position PX of the reference point in the UAV 1 is calculated. Thus, by arranging the ranging apparatus 20 such as the laser scanner, or other measurement apparatus at the reference point, highly accurate measurement based on the estimated posture and the estimated position can be performed.

(3) Based on the position data items and the observation data items, the estimated reception positions PEj of the receivers 18 are calculated, and whether or not each of the estimated reception positions PEj of the receivers 18 is proper is determined based on the predetermined criterion. This criterion relates to the displacements between the reception positions at which, in the UAV 1, the receivers 18 receive the signals from the satellites 7, and the calculated estimated-reception positions PEj of the receivers 18. This criterion is set such that ones of the estimated reception positions PEj, which are largely displaced from the reception positions of the receivers 18 in the UAV 1, are determined to be improper. The estimated position PX of the reference point is calculated based on ones of the estimated reception positions PEj of the receivers 18, which are determined to be proper by the determination, and on the posture of the UAV 1, which is estimated by the posture estimation unit 531. Thus, the improper ones of the estimated reception positions PEj, which are largely displaced from the reception positions of the receivers 18 in the UAV 1, are no longer used for the calculation of the estimated position PX of the reference point. Thus, accuracy of the estimated position PX of the reference point can be increased.

(4) At the time of determining whether or not each of the estimated reception positions PEj of the receivers 18 is proper, the determination procedure (ST325 to ST335) is executed with respect to each of the receivers 18. In the determination procedure, the estimated reception position PEj of the one of the receivers 18-j is set as the reference position PSj, and whether or not each of the estimated reception positions PEk of the other receivers 18-k (k≠j) is proper is determined. Specifically, based on the posture (transformation matrix A) of the UAV 1, which is estimated by the posture estimation unit 531, and on the reference position PSj, the target positions PTjk of the other receivers 18-k are calculated. The determination as to whether or not the distance Djk between the target position PTjk and the estimated reception position PEk falls within the predetermined range is made with respect to each of the other receivers 18-k. After the determination procedure (ST325 to ST335) with respect to each of the receivers 18 is executed in this way, based on the results of these determinations, whether or not each of the estimated reception positions PEj of the receivers 18 is proper is determined. Thus, the improper ones of the estimated reception positions PEj, which are largely displaced from the reception positions of the receivers 18 in the UAV 1, can be effectively distinguished.

(5) When two or more of the estimated reception positions PEj of the receivers 18 are determined to be proper by the determination procedures (ST325 to ST335), the estimated position PX of the reference point is obtained by equalizing two or more of the estimated positions PXj of the reference point, which are calculated from these two or more of the estimated reception positions PEj of the receivers 18. Thus, the accuracy of the estimated position PX of the reference point can be increased.

(6) At the time of calculating the estimated position of the reference point, the low-accuracy ones of the estimated reception positions PEj (estimated reception positions PEj each being the non-integer solution as the integer ambiguity) are excluded from the estimated reception positions PEj that are used for the calculation. With this, the lower-accuracy ones of the estimated reception positions PEj are no longer used for the calculation of the estimated position PX of the reference point. Thus, the accuracy of the estimated position PX of the reference point can be increased.

(7) The score (such as standard deviation) indicating the degree of the variation of the SNRs of the received signals at the same time point and from the same satellite 7 among the “N” receivers 18 is calculated with respect to each of the satellites 7. Then, based on the score calculated with respect to each of the satellites 7, whether or not each of the received signals from the satellites 7 is normal is determined. When fading of the received signals due to multipath has occurred, how the received signals vary due to the fading are different among the six receivers 18. Thus, the degree of the SNR variation among the six receivers 18 at the same time point increases. As a result, based on the score indicating the SNR variation, whether or not the variations of the received signals due to the fading have occurred can be determined. The estimated reception positions PEj of the receivers 18 are calculated with use of the observation data items based on the received signals, which are determined to be normal by the determination. Thus, influence of the multipath on the results of the calculation of the estimated reception positions PEj is suppressed.

(8) When the posture of the UAV 1 is varied with respect to the reference posture, two or more of the baseline vectors vary with respect to corresponding two or more of the reference vectors V. Differences between two or more of the observation vectors W, which are calculated with respect to two or more of the pairs of the receivers 18, and corresponding two or more of the reference vectors V represent differences of the posture of the UAV 1 from the reference posture. Thus, based on these two or more of the observation vectors W and on these two or more of the reference vectors V, the posture of the UAV 1 can be accurately estimated.

(9) Whether or not the error Ei between the length of each of the calculated observation vectors Wi and the length of each of the reference vectors Vi corresponding respectively to these observation vectors Wi falls within the predetermined range (Ei<Eth) is determined. Then, at the time of estimating the posture of the UAV 1, the posture is estimated based on two or more of the observation vectors Wi, the error Ei of each of which is determined to fall within the predetermined range, and on two or more of the reference vectors Vi, which correspond to these two or more of the observation vectors Wi. Thus, ones of the observation vectors Wi, the errors of each of which between the length of each of the observation vectors Wi and the length of each of the reference vectors Vi corresponding respectively to these observation vectors Wi being large, are no longer used for the posture estimation. As a result, accuracy of the posture estimation can be increased.

(10) The transformation matrix A that defines the transformations between the two or more of the reference vectors Vi and the two or more of the observation vectors Wi, which correspond one by one to each other, is calculated such that the objective function L(A) is minimized. The objective function L(A) expressed by the equation (2-1) is a function in accordance with a sum of vector error amounts (|Wi−A*Vi|²) that are obtained from all pairs of the reference vectors Vi and the observation vectors Wi corresponding to each other. Thus, by the transformation matrix A that minimizes the objective function L(A), the vector error amounts of each of the pairs decreases as a whole. The vector error amounts each have the value in accordance with the difference between the vector that is obtained by the transformation of the one in each of the pairs of the reference vectors Vi and the observation vectors Wi, and the other one in corresponding one of the pairs of these vectors. Therefore, when the vector error amounts are small, errors in the transformations between the reference vectors Vi and the observation vectors Wi by the transformation matrix A are also small. Thus, when the transformation matrix A is calculated such that the objective function L(A) is minimized, the transformation matrix A that accurately represents the difference of the posture from the reference posture can be obtained.

(11) At the time of estimating the posture of the UAV 1, the posture is estimated based on two or more of the observation vectors Wi, which correspond to the FIX solutions, and on two or more of the reference vectors Vi, which correspond to these two or more of the observation vectors Wi, the two or more corresponding to the FIX solutions. With this, low-accuracy ones of the observation vectors Wi, which correspond to the FLOAT solutions, are no longer used for the estimation of the posture of the UAV 1. Thus, the accuracy of the posture estimation can be increased.

(12) In each of the pairs of the receivers 18, solutions of the integer ambiguities (an integer solutions or a non-integer solutions) from two of the observation vectors Wi, which are opposite to each other, may be unequal to each other. Thus, by calculating the two observation vectors Wi with respect to each of the pairs of the receivers 18, a frequency at which the observation vectors corresponding to the FIX solutions (FIX rate) can be acquired increases.

(13) The ranging apparatus 20 that measures the distance from the reference point to the object in synchronization with the signals of the six receivers 18, which are received from the satellites 7, is arranged at the reference point in the UAV 1. Thus, based on the results of the estimation of the position and the posture of the UAV 1, and on the result of the distance measurement by the ranging apparatus 20, a precise three-dimensional data item of the target can be obtained.

The present disclosure is not limited the embodiment described hereinabove, and may be carried out in various forms.

The number of the (six) receivers 18 that are installed in the UAV 1 (information collection apparatus 10) in the embodiment described hereinabove is merely an example, and hence is not limited thereto as long as fewest-possible three or more receivers 18 for enabling the posture estimation are provided.

Further, the information collection apparatus 10 is installed in the UAV 1 in the example of the embodiment described hereinabove, but the mobile body in the present disclosure is not limited to the UAV. As other examples of the mobile body, there may be mentioned a vehicle that travels on the ground, and a ship that sails on the sea. In addition, the mobile body is not limited to unmanned vehicles, and may be vehicles that move with a person riding thereon.

The present disclosure is not limited to the example of the embodiment described hereinabove, in which the UAV 1 that flies in the air includes the ranging apparatus 20 such as the laser scanner, and generates the three-dimensional map by utilizing the result of the measurement by the ranging apparatus 20 and the results of the estimation of the position and the posture. As another example of the present disclosure, a camera that captures the ground surface may be installed instead of the ranging apparatus 20. In addition, the results of the estimation of the position and the posture of the mobile body may be utilized for measurements other than the surveying, or may be utilized for purposes other than the measurements (such as a purpose of automatically recording and controlling the position and the posture of the mobile body, and a purpose of precisely estimating its orientations).

Below, appendices of this embodiment are described.

### APPENDIX 1

An apparatus (5) that estimates a position and a posture of a mobile body (1), the apparatus (5) comprising:

a posture estimation unit (531) that estimates the posture of the mobile body (1)
based on observation data items generated based on signals that “N” (N is an integer number of three or more) receivers (18-1 to 18-6) installed in the mobile body (1) each have received from a plurality of satellites (7), and
based on position data items of the plurality of satellites (7); and a position estimation unit (532) that estimates the position of the mobile body (1) based on the observation data items and on the position data items,

the observation data items including information items about distances between the plurality of satellites (7) and “N” reception positions at which the “N” receivers (18-1 to 18-6) receive the signals from the plurality of satellites (7),

the position estimation unit (532)
calculating, based on the position data items and on the observation data items, two or more estimated reception positions at which two or more receivers of the “N” receivers (18-1 to 18-6) are estimated to receive the signals from the plurality of satellites (7),
determining, based on a determination criterion for displacements between the two or more reception positions of the two or more receivers and the two or more estimated reception positions of the two or more receivers, whether or not each of the two or more estimated reception positions is proper, and
calculating estimated positions of a reference point in the mobile body (1)
   based on ones of the two or more estimated reception positions, the ones being determined to be proper by the determination, and
   based on the posture of the mobile body (1), the posture being estimated by the posture estimation unit (531).

According to the apparatus (5) of Appendix 1, the “N” (three or more) receivers (18-1 to 18-6) installed in the mobile body (1) generate the observation data items based on the signals that the receivers (18-1 to 18-6) have received from the plurality of satellites (7). The observation data items include the information items about the distances from the plurality of satellites (7) to the reception positions of the receivers (18-1 to 18-6). Based on these observation data items and on the position data items of the plurality of satellites (7), the posture of the mobile body (1) is estimated, and the position of the mobile body (1) is estimated. With this, even without installing the IMU in the mobile body (1), the posture of the mobile body (1) can be estimated with high accuracy by “N” six receivers (18-1 to 18-6). Further, even without installing high-accuracy receivers such as a dual-frequency GNSS receiver into the mobile body (1), the position of the mobile body (1) can be estimated with high accuracy. Thus, the posture and the position of the mobile body (1) can be estimated with high accuracy with use of the observation data items that are obtained by the low-cost mobile body (1).

Further, according to the apparatus (5) of Appendix 1, based on the position data items and on the observation data items, the two or more estimated reception positions of the two or more receivers (18-1 to 18-6) installed in the mobile body (1) is calculated. Based on the calculated estimated-reception positions and on the posture of the mobile body (1), which is estimated by the posture estimation unit (531), the estimated positions of the reference point in the mobile body (1) are calculated. Thus, by arranging the ranging apparatus such as the laser scanner at the reference point, highly accurate measurement based on the estimated posture and the estimated positions can be performed.

Still further, according to the apparatus (5) of Appendix 1, based on the position data items and the observation data items, the estimated reception positions of the receivers (18-1 to 18-6) are calculated, and whether or not each of the estimated reception positions of the receivers (18-1 to 18-6) is proper is determined based on the predetermined criterion. This criterion relates to the displacements between the reception positions at which, in the mobile body (1), the receivers (18-1 to 18-6) receive the signals from the satellites (7), and to the calculated estimated-reception positions of the receivers (18-1 to 18-6). This criterion is set such that ones of the estimated reception positions, which are largely displaced from the reception positions of the receivers (18-1 to 18-6) in the mobile body (1), are determined to be improper. The estimated positions of the reference point are calculated based on ones of the estimated reception positions of the receivers (18-1 to 18-6), which are determined to be proper by the determination, and on the posture of the mobile body (1), which is estimated by the posture estimation unit (531). Thus, the improper ones of the estimated reception positions, which are largely displaced from the reception positions of the receivers (18-1 to 18-6) in the mobile body (1), are no longer used for the calculation of the estimated positions of the reference point. Thus, accuracy of the estimated positions of the reference point is increased.

### APPENDIX 2

The apparatus (5) that estimates the position and the posture of the mobile body (1) according to Appendix 1,

wherein, when the position estimation unit (532) determines whether or not each of the two or more estimated reception positions of the “N” receivers (18-1 to 18-6) is proper, the position estimation unit (532) executes, with respect to each of the two or more receivers, a determination procedure for determining, by setting one of the estimated reception positions of one of the two or more receivers as a reference position, whether or not other ones of the estimated reception positions of other ones of the two or more receivers are proper,

wherein, in the determination procedure, based on the posture of the mobile body (1), the posture being estimated by the posture estimation unit (531), and on the reference position, the position estimation unit (532) calculates target positions that should be ones of the reception positions of the other ones of the two or more receivers,

wherein, in the determination procedure, the position estimation unit (532) determines whether or not distances between the target positions of the other ones of the two or more receivers and the other ones of the estimated reception positions of the other ones of the two or more receivers each fall within a predetermined range, and

wherein the position estimation unit (532) determines, based on results of the determination procedure executed on each of the two or more receivers, whether or not each of the estimated reception positions of the two or more receivers is proper.

With this configuration, at the time of determining whether or not each of the estimated reception positions of the receivers (18-1 to 18-6) is proper, the determination procedure is executed with respect to each of the receivers (18-1 to 18-6). In the determination procedure, the estimated reception position of the one of the receivers (18-1 to 18-6) is set as the reference position, and whether or not each of the estimated reception positions of the other ones of the receivers (18-1 to 18-6) is proper is determined. Specifically, based on the posture (transformation matrix A) of the mobile body (1), which is estimated by the posture estimation unit (531), and on the reference position, the target positions of the other ones of the receivers (18-1 to 18-6) are calculated. The determination as to whether or not the distance between the target position and the estimated reception position falls within the predetermined range is made with respect to each of the other ones of the receivers (18-1 to 18-6). After the determination procedure with respect to each of the receivers (18-1 to 18-6) is executed in this way, based on the results of these determinations, whether or not each of the estimated reception positions of the receivers (18-1 to 18-6) is proper is determined. Thus, the improper ones of the estimated reception positions, which are largely displaced from the reception positions of the receivers (18-1 to 18-6) in the mobile body (1), can be effectively distinguished.

### APPENDIX 3

The apparatus (5) that estimates the position and the posture of the mobile body (1) according to Appendix 1 or 2, wherein, when the position estimation unit (532) determines that a plurality of the estimated reception positions are proper, the position estimation unit (532) equalizes a plurality of the estimated positions of the reference point, the plurality of the estimated positions of the reference point being calculated from the plurality of the estimated reception positions.

With this configuration, a final estimated position of the reference point is obtained by equalizing the plurality of the estimated positions, which are calculated from the plurality of estimated reception positions, the plurality of the estimated reception positions being determined to be proper. Thus, the accuracy of the final estimated position of the reference point is increased.

### APPENDIX 4

The apparatus (5) that estimates the position and the posture of the mobile body (1) according to any one of Appendices 1 to 3,

wherein, when the position estimation unit (532) calculates the estimated reception positions of the “N” receivers (18-1 to 18-6), the position estimation unit (532) calculates one of
high-accuracy ones of the estimated reception positions, the high-accuracy ones each obtained when an integer ambiguity of carrier phases of the signals that are propagated from the plurality of satellites is solved as an integer solution, and
low-accuracy ones of the estimated reception positions, the low-accuracy ones each obtained when the integer ambiguity is solved as a non-integer solution, and

wherein, when the position estimation unit (532) calculates the estimated positions of the reference point, the position estimation unit (532) excludes the low-accuracy ones of the estimated reception positions from the estimated reception positions that are used for the calculation of the estimated positions of the reference point.

With this configuration, at the time of calculating the estimated position of the reference point, the low-accuracy ones of the estimated reception positions are excluded from the estimated reception positions that are used for the calculation. With this, the lower-accuracy ones of the estimated reception positions are no longer used for the calculation of the estimated positions of the reference point. Thus, the accuracy of the estimated positions of the reference point is increased.

### APPENDIX 5

The apparatus (5) that estimates the position and the posture of the mobile body (1) according to any one of Appendices 1 to 4,

wherein the observation data items includes information items about signal-to-noise ratios of the received signals from the plurality of satellites (7)

wherein the position estimation unit (532)
calculates, based on the observation data items including the information items about the signal-to-noise ratios, a score indicating a degree of a variation of the signal-to-noise ratios of the received signals at a same time point and from a same one of the plurality of satellites (7) among the “N” receivers (18-1 to 18-6), the score being calculated with respect to each of the plurality of satellites (7),
determines, based on the score calculated with respect to each of the plurality of satellites (7), whether or not each of the received signals from the plurality of satellites (7) is normal, and
uses, when the position estimation unit (532) calculates the estimated reception positions, ones of the observation data items based on ones of the received signals from the plurality of satellites (7), the ones of the received signals being determined to be normal.

With this configuration, the score is calculated with respect to each of the satellites (7). Then, based on the score calculated with respect to each of the satellites (7), whether or not each of the received signals from the satellites (7) is normal is determined. This score indicates the degree of the variation of the signal-to-noise ratios of the received signals at the same time point and from the same one of the satellite (7) among the “N” receivers (18-1 to 18-6). When fading of the received signals due to multipath has occurred, how the received signals vary due to the fading are different among the “N” receivers (18-1 to 18-6). Thus, the degree of the variation of the signal-to-noise ratios among the “N” receivers (18-1 to 18-6) at the same time point increases. As a result, based on the score indicating the variation of the signal-to-noise ratios, whether or not the variations of the received signals due to the fading have occurred can be determined. The estimated reception positions of the “N” receivers (18-1 to 18-6) are calculated with use of the observation data items based on the received signals, which are determined to be normal by the determination. Thus, influence of the multipath on the results of the calculation of the estimated reception positions is suppressed.

### APPENDIX 6

An apparatus (5) that estimates a position and a posture of a mobile body (1), the apparatus comprising:

a posture estimation unit (531) that estimates the posture of the mobile body (1)
based on observation data items generated based on signals that “N” (N is an integer number of three or more) receivers (18-1 to 18-6) installed in the mobile body (1) each have received from a plurality of satellites (7), and
based on position data items of the plurality of satellites (7); and

a position estimation unit (532) that estimates the position of the mobile body (1) based on the observation data items and on the position data items,

the observation data items including
information items about distances between the plurality of satellites (7) and “N” reception positions at which the “N” receivers (18-1 to 18-6) receive the signals from the plurality of satellites (7), and
information items about signal-to-noise ratios of received signals from the plurality of satellites (7),

the position estimation unit (532)
calculating, based on the observation data items including the information items about the signal-to-noise ratios, a score indicating a degree of a variation of the signal-to-noise ratios of the received signals at a same time point and from a same one of the plurality of satellites (7) among the “N” receivers (18-1 to 18-6), the score being calculated with respect to each of the plurality of satellites (7),
determining, based on the score calculated with respect to each of the plurality of satellites (7), whether or not each of the received signals from the plurality of satellites (7) is normal,
calculating, based on ones of the observation data items based on ones of the received signals from the plurality of satellites (7), the ones of the received signals being determined to be normal, and based on the position data items, estimated reception positions at which one or more of the “N” receivers (18-1 to 18-6) are estimated to receive the signals from the plurality of satellites (7), and
calculating estimated positions of a reference point in the mobile body (1)
   based on the posture of the mobile body (1), the posture being estimated by the posture estimation unit (531), and
   based on the estimated reception positions.

### APPENDIX 7

The apparatus (5) that estimates the position and the posture of the mobile body (1) according to any one of Appendices 1 to 6, in which the posture estimation unit (531)

calculates, based on the observation data items and on the position data items, a plurality of baseline vectors in a plurality of pairs of the “N” receivers (18-1 to 18-6) as a plurality of observation vectors, the baseline vectors each being a vector defined by two reception positions of two receivers of the “N” receivers (18-1 to 18-6), and

estimates the posture of the mobile body (1) based on the plurality of calculated observation vectors, and on a plurality of reference vectors corresponding to the plurality of calculated observation vectors, the plurality of reference vectors each being the baseline vector under a state in which the posture of the mobile body (1) is a predetermined reference posture.

With this configuration, when the posture of the mobile body (1) is varied with respect to the reference posture, the plurality of baseline vectors vary with respect to the corresponding plurality of reference vectors. Differences between the plurality of observation vectors, which are calculated with respect to the plurality of pairs of the receivers (18-1 to 18-6), and the corresponding plurality of reference vectors represent differences of the posture of the mobile body (1) from the reference posture. Thus, based on these plurality of observation vectors and on the corresponding plurality of reference vectors, the posture of the mobile body (1) can be estimated.

### APPENDIX 8

An apparatus (5) that estimates a position and a posture of a mobile body (1), the apparatus comprising:

a posture estimation unit (531) that estimates the posture of the mobile body (1)
based on observation data items generated based on signals that “N” (N is an integer number of three or more) receivers (18-1 to 18-6) installed in the mobile body (1) each have received from a plurality of satellites (7), and
based on position data items of the plurality of satellites (7); and

a position estimation unit (532) that estimates the position of the mobile body (1) based on the observation data items and on the position data items,

the observation data items including information items about distances between the plurality of satellites (7) and “N” reception positions at which the “N” receivers (18-1 to 18-6) receive the signals from the plurality of satellites (7),

the position estimation unit (532)
calculating, based on the position data items and on the observation data items, estimated reception positions at which one or more of the “N” receivers (18-1 to 18-6) are estimated to receive the signals from the plurality of satellites (7), and
calculating estimated positions of a reference point in the mobile body (1)
   based on the posture of the mobile body (1), the posture being estimated by the posture estimation unit (531), and
   based on the estimated reception positions,

the posture estimation unit (531)
calculating, based on the observation data items and on the position data items, a plurality of baseline vectors in a plurality of pairs of the “N” receivers (18-1 to 18-6) as a plurality of observation vectors, the plurality of baseline vectors each being a vector defined by two reception positions of two receivers of the “N” receivers (18-1 to 18-6), and
estimating the posture of the mobile body (1) based on the plurality of calculated observation vectors, and on a plurality of reference vectors corresponding to the plurality of calculated observation vectors, the plurality of reference vectors each being the baseline vector under a state in which the posture of the mobile body (1) is a predetermined reference posture.

### APPENDIX 9

The apparatus (5) that estimates the position and the posture of the mobile body (1) according to Appendix 7 or 8,

wherein the posture estimation unit (531)
calculates the plurality of observation vectors with respect to at least a part of the pairs of the “N” receivers (18-1 to 18-6),
determines whether or not an error between a length of each of the plurality of calculated observation vectors and a length of each of the plurality of reference vectors corresponding to the plurality of calculated observation vectors falls within a predetermined range, and

wherein, when the posture estimation unit (531) estimates the posture of the mobile body (1), the posture estimation unit (531) estimates the posture
based on two or more observation vectors of the plurality of observation vectors, the error of each of the two or more observation vectors of the plurality of observation vectors being determined to fall within the predetermined range, and
based on the two or more reference vectors corresponding to the two or more observation vectors of the plurality of observation vectors.

With this configuration, whether or not the error between the length of each of the calculated observation vectors and the length of each of the reference vectors corresponding to these observation vectors falls within the predetermined range is determined. Then, at the time of estimating the posture of the mobile body (1), the posture is estimated based on the two or more observation vectors, the error of each of which is determined to fall within the predetermined range, and on the two or more reference vectors corresponding to these two or more observation vectors. Thus, ones of the observation vectors, the errors of each of which between the length of each of the observation vectors and the length of each of the reference vectors corresponding to these observation vectors being large, are no longer used for the posture estimation. As a result, accuracy of the posture estimation is increased.

### APPENDIX 10

The apparatus (5) that estimates the position and the posture of the mobile body (1) according to Appendix 9,

wherein, when the posture estimation unit (531) estimates the posture of the mobile body (1) based on the two or more reference vectors and on the two or more observation vectors, the posture estimation unit (531) calculates a transformation matrix that defines transformations between the two or more reference vectors and the two or more observation vectors such that an objective function is minimized, the two or more reference vectors and the two or more observation vectors corresponding one by one to each other,

wherein the objective function is a function in accordance with a sum of vector error amounts that are obtained from all corresponding pairs of the two or more reference vectors and the two or more observation vectors, and

wherein the vector error amounts each have a value in accordance with a difference between
a vector that is obtained by a transformation of one in one of the corresponding pairs of the two or more reference vectors and the two or more observation vectors, and
another one in the one of the corresponding pairs of the two or more reference vectors and the two or more observation vectors.

With this configuration, the transformation matrix that defines the transformations between the two or more reference vectors and the two or more observation vectors, which correspond one by one to each other, is calculated such that the objective function is minimized. The objective function is the function in accordance with the sum of the vector error amounts that are obtained from all the pairs of the reference vectors and the observation vectors corresponding to each other. Thus, by the transformation matrix that minimizes the objective function, the vector error amounts of each of the pairs decrease as a whole. The vector error amounts each have the value in accordance with the difference between the vector that is obtained by the transformation of the one in each of the pairs of the reference vectors and the observation vectors, and the other one in corresponding one of the pairs of these vectors. Therefore, when the vector error amounts are small, errors in the transformations between the reference vectors and the observation vectors by the transformation matrix are also small. Thus, when the transformation matrix is calculated such that the objective function is minimized, the transformation matrix that accurately represents the difference of the posture from the reference posture is obtained.

### APPENDIX 11

The apparatus (5) that estimates the position and the posture of the mobile body (1) according to any one of Appendices 7 to 10,

wherein, when the posture estimation unit (531) calculates the plurality of observation vectors, the posture estimation unit (531) calculates one of
high-accuracy ones of the plurality of observation vectors, the high-accuracy ones each obtained when an integer ambiguity of carrier phases of the signals that are propagated from the plurality of satellites (7) is solved as an integer solution, and
low-accuracy ones of the plurality of observation vectors, the low-accuracy ones each obtained when the integer ambiguity is solved as a non-integer solution, and

wherein, when the posture estimation unit (531) estimates the posture of the mobile body (1), the posture estimation unit (531) estimates the posture based on the high-accuracy ones of the two or more observation vectors, and on ones of the two or more reference vectors, the ones of the two or more reference vectors corresponding to the high-accuracy ones of the two or more observation vectors.

With this configuration, at the time of estimating the posture of the mobile body (1), the posture is estimated based on the high-accuracy ones of the two or more observation vectors, and the ones of the two or more reference vectors corresponding to these high-accuracy ones of the two or more observation vectors. With this, the low-accuracy ones of the observation vectors are no longer used for the estimation of the posture of the mobile body (1). Thus, the accuracy of the posture estimation is increased.

### APPENDIX 12

The apparatus (5) that estimates the position and the posture of the mobile body (1) according to Appendix 11, wherein the observation vectors that the posture estimation unit (531) calculates with respect to each of the pairs of the “N” receivers (18-1 to 18-6) include two observation vectors opposite to each other.

With this configuration, in each of the pairs of the receivers (18-1 to 18-6), solutions of the integer ambiguities (an integer solutions or a non-integer solutions) from the two observation vectors opposite to each other may be unequal to each other. Thus, by calculating the two observation vectors with respect to each of the pairs of the receivers (18-1 to 18-6), a frequency at which the high-accuracy ones of the observation vectors can be acquired increases.

### APPENDIX 13

A non-transitory computer-readable medium that stores therein a program for causing a computer to function as the position estimation unit (532) and the posture estimation unit (531) of the apparatus according to any one of Appendices 1 to 12.

### APPENDIX 14

A system that estimates a position and a posture of a mobile body (1), the system comprising:

“N” (N is an integer number of three or more) receivers (18-1 to 18-6) installed in the mobile body (1), the “N” receivers each receiving signals that are broadcasted from a plurality of satellites (7), and each generating, based on the received signals, observation data items including information items about distances from the plurality of satellites (7); and

the apparatus (5) according to any one of Appendices 1 to 12.

### APPENDIX 15

The system that estimates the position and the posture of the mobile body (1) according to Appendix 14, further comprising a ranging apparatus (20) that is located at the reference point in the mobile body, and that measures a distance from the reference point to a target in synchronization with the reception of the signals from the plurality of satellites (7) via the “N” receivers (18-1 to 18-6).

With this configuration, based on results of the estimation of the position and the posture of the mobile body (1), and on result of the distance measurement by the ranging apparatus (20), a precise three-dimensional data item of the target can be obtained.

### APPENDIX 16

A method of estimating a position and a posture of a mobile body (1), the method comprising:

estimating the posture of the mobile body (1)
based on observation data items generated based on signals that “N” (N is an integer number of three or more) receivers (18-1 to 18-6) installed in the mobile body (1) each have received from a plurality of satellites (7), and
based on position data items of the plurality of satellites (7); and

estimating the position of the mobile body (1) based on the observation data items and on the position data items,

the observation data items including information items about distances from the plurality of satellites (7) to the “N” receivers (18-1 to 18-6),

the estimating of the position of the mobile body (1) including
calculating, based on the position data items and on the observation data items, estimated reception positions at which the “N” receivers (18-1 to 18-6) are estimated to receive the signals from the plurality of satellites (7),
determining, based on a determination criterion for displacements between reception positions of the “N” receivers (18-1 to 18-6) and the estimated reception positions of the “N” receivers (18-1 to 18-6), whether or not each of the estimated reception positions of the “N” receivers (18-1 to 18-6) is proper, and
calculating estimated positions of a reference point in the mobile body (1)
   based on ones of the estimated reception positions of the “N” receivers (18-1 to 18-6), the ones being determined to be proper by the determination, and
   based on the estimated posture of the mobile body (1).

### APPENDIX 17

A method of estimating a position and a posture of a mobile body (1), the method comprising:

estimating the posture of the mobile body (1)
based on observation data items generated based on signals that “N” (N is an integer number of three or more) receivers (18-1 to 18-6) installed in the mobile body (1) each have received from a plurality of satellites (7), and
based on position data items of the plurality of satellites (7); and

estimating the position of the mobile body (1) based on the observation data items and on the position data items,

the observation data items including
information items about distances from the plurality of satellites (7) to the “N” receivers (18-1 to 18-6), and
information items about signal-to-noise ratios of received signals from the plurality of satellites (7),

the estimating of the position of the mobile body (1) including
calculating, based on the observation data items including the information items about the signal-to-noise ratios, a score indicating a degree of a variation of the signal-to-noise ratios of the received signals at a same time point and from a same one of the plurality of satellites (7) among the “N” receivers (18-1 to 18-6), the score being calculated with respect to each of the plurality of satellites (7),
determining, based on the score calculated with respect to each of the plurality of satellites (7), whether or not each of the received signals from the plurality of satellites (7) is normal,
calculating, based on ones of the observation data items based on ones of the received signals from the plurality of satellites (7), the ones of the received signals being determined to be normal, and based on the position data items, estimated reception positions at which one or more of the “N” receivers (18-1 to 18-6) are estimated to receive the signals from the plurality of satellites (7), and
calculating, based on the estimated posture of the mobile body (1) and on the estimated reception positions, estimated positions of a reference point in the mobile body (1).

### APPENDIX 18

A method of estimating a position and a posture of a mobile body (1), the method comprising:

estimating the posture of the mobile body (1)
based on observation data items generated based on signals that “N” (N is an integer number of three or more) receivers (18-1 to 18-6) installed in the mobile body (1) each have received from a plurality of satellites (7), and
based on position data items of the plurality of satellites (7); and

estimating the position of the mobile body (1) based on the observation data items and on the position data items,

the observation data items including information items about distances from the plurality of satellites (7) to the “N” receivers (18-1 to 18-6),

the estimating of the position of the mobile body (1) including
calculating, based on the position data items and on the observation data items, estimated reception positions at which one or more of the “N” receivers (18-1 to 18-6) are estimated to receive the signals from the plurality of satellites (7), and
calculating, based on the estimated posture of the mobile body (1) and on the estimated reception positions, estimated positions of a reference point in the mobile body (1),

the estimating of the posture of the mobile body (1) including
calculating, based on the observation data items and on the position data items, a plurality of baseline vectors in a plurality of pairs of the “N” receivers (18-1 to 18-6) as a plurality of observation vectors, the plurality of baseline vectors each being a vector defined by two reception positions of two receivers of the “N” receivers (18-1 to 18-6), and
estimating the posture of the mobile body (1) based on the plurality of calculated observation vectors and on a plurality of reference vectors corresponding to the plurality of calculated observation vectors, the plurality of reference vectors each being the baseline vector under a state in which the posture of the mobile body (1) is a predetermined reference posture.

### REFERENCE SIGNS LIST

1 UAV
10 information collection apparatus
11 frame
12 body portion
17-1 to 17-6 arm portion
18-1 to 18-6, 18A receiver
19-1 to 19-6, 19A antenna
20 ranging apparatus
21 control apparatus
22 processing unit
23 storage unit
24 drone
25 body portion
26-1 to 26-6 propeller
27-1 to 27-6 arm portion
3 terrestrial reference station
5 information processing apparatus
51 interface unit
52 display unit
53 processing unit
531 posture estimation unit
532 position estimation unit
533 three-dimensional-map generating unit
54 storage unit
541 program
7 satellite
9 ground surface
V, VA1 to VA15, VB1 to VB15 reference vector
W, WA1 to WA15, WB1 to WB15 observation vector
PS reference position
PT target position
PE estimated reception position

1-17. (canceled)

18. An apparatus that estimates a position and a posture of a mobile body, the apparatus comprising:
a posture estimation unit that estimates the posture of a mobile body
based on observation data items generated based on signals that “N” (N is an integer number of three or more) receivers installed in the mobile body each have received from a plurality of satellites, and
based on position data items of the plurality of satellites; and
a position estimation unit that estimates the position of the mobile body based on the observation data items and on the position data items,
the observation data items include information items about distances between the plurality of satellites and “N” reception positions at which the “N” receivers receive the signals from the plurality of satellites,
the position estimation unit calculating, based on the position data items and on the observation data items, two or more estimated reception positions at which two or more receivers of the “N” receivers are estimated to receive the signals from the plurality of satellites,
determining, based on a determination criterion for displacement between the two or more reception positions of the two or more receivers and the two or more estimated reception positions of the two or more receivers, whether or not each of the two or more estimated reception positions is proper, and
calculating estimated positions of a reference point in the mobile body
based on ones of the two or more estimated reception positions, the ones being determined to be proper by the determination, and
based on the posture of the mobile body, the posture being estimated by the posture estimation unit.

19. The apparatus that estimates the position and the posture of the mobile body according to claim 18,
wherein, when the position estimation unit determines whether or not each of the two or more estimated reception positions is proper, the position estimation unit executes, with respect to each of the two or more receivers, a determination procedure for determining, by setting one of the estimated reception positions of one of the two or more receivers as a reference position, whether or not other ones of the estimated reception positions of other ones of the two or more receivers are proper,
wherein, in the determination procedure, based on the posture of the mobile body, the posture being estimated by the posture estimation unit, and on the reference position, the position estimation unit calculates target positions that should be ones of the reception positions of the other ones of the two or more receivers,
wherein, in the determination procedure, the position estimation unit determines whether or not distances between the target positions of the other ones of the two or more receivers and the other ones of the estimated reception positions of the other ones of the two or more receivers each fall within a predetermined range, and
wherein the position estimation unit determines, based on results of the determination procedure executed on each of the two or more receivers, whether or not each of the estimated reception positions of the two or more receivers is proper.

20. The apparatus that estimates the position and the posture of the mobile body according to claim 18, wherein, when the position estimation unit determines that a plurality of the estimated reception positions are proper, the position estimation unit equalizes a plurality of the estimated positions of the reference point, the plurality of the estimated positions of the reference point being calculated from the plurality of the estimated reception positions.

21. The apparatus that estimates the position and the posture of the mobile body according to claim 18,
wherein, when the position estimation unit calculates the estimated reception positions of the “N” receivers, the position estimation unit calculates one of
high-accuracy ones of the estimated reception positions, the high-accuracy ones each obtained when an integer ambiguity of carrier phases of the signals that are propagated from the plurality of satellites is solved as an integer solution, and
low-accuracy ones of the estimated reception positions, the low-accuracy ones each obtained when the integer ambiguity is solved as a non-integer solution, and
wherein, when the position estimation unit calculates the estimated positions of the reference point, the position estimation unit excludes the low-accuracy ones of the estimated reception positions from the estimated reception positions that are used for the calculation of the estimated positions of the reference point.

22. The apparatus that estimates the position and the posture of the mobile body according to claim 18,
wherein the observation data items include information items about signal-to-noise ratios of the received signals from the plurality of satellites
wherein the position estimation unit
calculates, based on the observation data items including the information items about the signal-to-noise ratios, a score indicating a degree of a variation of the signal-to-noise ratios of the received signals at a same time point and from a same one of the plurality of satellites among the “N” receivers, the score being calculated with respect to each of the plurality of satellites,
determines, based on the score calculated with respect to each of the plurality of satellites, whether or not each of the received signals from the plurality of satellites is normal, and
uses, when the position estimation unit calculates the estimated reception positions, ones of the observation data items based on ones of the received signals from the plurality of satellites, the ones of the received signals being determined to be normal.

23. An apparatus that estimates a position and a posture of a mobile body, the apparatus comprising:
a posture estimation unit that estimates the posture of the mobile body
based on observation data items generated based on signals that “N” (N is an integer number of three or more) receivers installed in the mobile body each have received from a plurality of satellites, and
based on position data items of the plurality of satellites; and
a position estimation unit that estimates the position of the mobile body based on the observation data items and on the position data items,
the observation data items including
information items about distances between the plurality of satellites and “N” reception positions at which the “N” receivers receive the signals from the plurality of satellites, and
information items about signal-to-noise ratios of received signals from the plurality of satellites,
the position estimation unit
calculating, based on the observation data items including the information items about the signal-to-noise ratios, a score indicating a degree of a variation of the signal-to-noise ratios of the received signals at a same time point and from a same one of the plurality of satellites among the “N” receivers, the score being calculated with respect to each of the plurality of satellites,
determining, based on the score calculated with respect to each of the plurality of satellites, whether or not each of the received signals from the plurality of satellites is normal,
calculating, based on ones of the observation data items based on ones of the received signals from the plurality of satellites, the ones of the received signals being determined to be normal, and based on the position data items, estimated reception positions at which one or more of the “N” receivers are estimated to receive the signals from the plurality of satellites, and
calculating estimated positions of a reference point in the mobile body
based on the posture of the mobile body, the posture being estimated by the posture estimation unit, and
based on the estimated reception positions.

24. The apparatus that estimates the position and the posture of the mobile body according to claim 18, wherein the posture estimation unit
calculates, based on the observation data items and on the position data items, a plurality of baseline vectors in a plurality of pairs of the “N” receivers as a plurality of observation vectors, the baseline vectors each being a vector defined by two reception positions of two receivers of the “N” receivers, and
estimates the posture of the mobile body based on the plurality of calculated observation vectors, and on a plurality of reference vectors corresponding to the plurality of calculated observation vectors, the plurality of reference vectors each being the baseline vector under a state in which the posture of the mobile body is a predetermined reference posture.

25. An apparatus that estimates a position and a posture of a mobile body, the apparatus comprising:
a posture estimation unit that estimates the posture of the mobile body
based on observation data items generated based on signals that “N” (N is an integer number of three or more) receivers installed in the mobile body each have received from a plurality of satellites, and
based on position data items of the plurality of satellites; and
a position estimation unit that estimates the position of the mobile body based on the observation data items and on the position data items,
the observation data items including information items about distances between the plurality of satellites and “N” reception positions at which the “N” receivers receive the signals from the plurality of satellites,
the position estimation unit
calculating, based on the position data items and on the observation data items, estimated reception positions at which one or more of the “N” receivers are estimated to receive the signals from the plurality of satellites, and
calculating estimated positions of a reference point in the mobile body
based on the posture of the mobile body, the posture being estimated by the posture estimation unit, and
based on the estimated reception positions,
the posture estimation unit
calculating, based on the observation data items and on the position data items, a plurality of baseline vectors in a plurality of pairs of the “N” receivers as a plurality of observation vectors, the plurality of baseline vectors each being a vector defined by two reception positions of two receivers of the “N” receivers, and
estimating the posture of the mobile body based on the plurality of calculated observation vectors, and on a plurality of reference vectors corresponding to the plurality of calculated observation vectors, the plurality of reference vectors each being the baseline vector under a state in which the posture of the mobile body is a predetermined reference posture.

26. The apparatus that estimates the position and the posture of the mobile body according to claim 25,
wherein the posture estimation unit
calculates the plurality of observation vectors with respect to at least a part of the pairs of the “N” receivers,
determines whether or not an error between a length of each of the plurality of calculated observation vectors and a length of each of the plurality of reference vectors corresponding to the plurality of calculated observation vectors falls within a predetermined range, and
wherein, when the posture estimation unit estimates the posture of the mobile body, the posture estimation unit estimates the posture
based on two or more observation vectors of the plurality of observation vectors, the error of each of the two or more observation vectors of the plurality of observation vectors being determined to fall within the predetermined range, and
based on the two or more reference vectors corresponding to the two or more observation vectors of the plurality of observation vectors.

27. The apparatus that estimates the position and the posture of the mobile body according to claim 26,
wherein, when the posture estimation unit estimates the posture of the mobile body based on the two or more reference vectors and on the two or more observation vectors, the posture estimation unit calculates a transformation matrix that defines transformations between the two or more reference vectors and the two or more observation vectors such that an objective function is minimized, the two or more reference vectors and the two or more observation vectors corresponding one by one to each other,
wherein the objective function is a function in accordance with a sum of vector error amounts that are obtained from all corresponding pairs of the two or more reference vectors and the two or more observation vectors, and
wherein the vector error amounts each have a value in accordance with a difference between
a vector that is obtained by a transformation of one in one of the corresponding pairs of the two or more reference vectors and the two or more observation vectors, and
another one in the one of the corresponding pairs of the two or more reference vectors and the two or more observation vectors.

28. The apparatus that estimates the position and the posture of the mobile body according to claim 25,
wherein, when the posture estimation unit calculates the plurality of observation vectors, the posture estimation unit calculates one of
high-accuracy ones of the plurality of observation vectors, the high-accuracy ones each obtained when an integer ambiguity of carrier phases of the signals that are propagated from the plurality of satellites is solved as an integer solution, and
low-accuracy ones of the plurality of observation vectors, the low-accuracy ones each obtained when the integer ambiguity is solved as a non-integer solution, and
wherein, when the posture estimation unit estimates the posture of the mobile body, the posture estimation unit estimates the posture based on the high-accuracy ones of the two or more observation vectors, and on ones of the two or more reference vectors, the ones of the two or more reference vectors corresponding to the high-accuracy ones of the two or more observation vectors.

29. The apparatus that estimates the position and the posture of the mobile body according to claim 28, wherein the observation vectors that the posture estimation unit calculates with respect to each of the pairs of the “N” receivers include two observation vectors opposite to each other.

30. A system that estimates a position and a posture of a mobile body, the system comprising:
“N” (N is an integer number of three or more) receivers installed in the mobile body, the “N” receivers each receiving signals that are broadcasted from a plurality of satellites, and each generating, based on the received signals, observation data items including information items about distances from the plurality of satellites; and
the apparatus according to claim 18.

31. The system that estimates the position and the posture of the mobile body according to claim 30, further comprising a ranging apparatus that is located at the reference point in the mobile body, and that measures a distance from the reference point to a target in synchronization with the reception of the signals from the plurality of satellites via the “N” receivers.

32. A method of estimating a position and a posture of a mobile body, the method comprising:
estimating the posture of the mobile body
based on observation data items generated based on signals that “N” (N is an integer number of three or more) receivers installed in the mobile body each have received from a plurality of satellites, and
based on position data items of the plurality of satellites; and
estimating the position of the mobile body based on the observation data items and on the position data items,
the observation data items including information items about distances from the plurality of satellites to the “N” receivers,
the estimating of the position of the mobile body including
calculating, based on the position data items and on the observation data items, estimated reception positions at which the “N” receivers are estimated to receive the signals from the plurality of satellites,
determining, based on a determination criterion for displacements between reception positions of the “N” receivers and the estimated reception positions of the “N” receivers, whether or not each of the estimated reception positions of the “N” receivers is proper, and
calculating estimated positions of a reference point in the mobile body
based on ones of the estimated reception positions of the “N” receivers, the ones being determined to be proper by the determination, and
based on the estimated posture of the mobile body.

33. A method of estimating a position and a posture of a mobile body, the method comprising:
estimating the posture of the mobile body
based on observation data items generated based on signals that “N” (N is an integer number of three or more) receivers installed in the mobile body each have received from a plurality of satellites, and
based on position data items of the plurality of satellites; and
estimating the position of the mobile body based on the observation data items and on the position data items,
the observation data items including
information items about distances from the plurality of satellites to the “N” receivers, and
information items about signal-to-noise ratios of received signals from the plurality of satellites,
the estimating of the position of the mobile body including
calculating, based on the observation data items including the information items about the signal-to-noise ratios, a score indicating a degree of a variation of the signal-to-noise ratios of the received signals at a same time point and from a same one of the plurality of satellites among the “N” receivers, the score being calculated with respect to each of the plurality of satellites,
determining, based on the score calculated with respect to each of the plurality of satellites, whether or not each of the received signals from the plurality of satellites is normal,
calculating, based on ones of the observation data items based on ones of the received signals from the plurality of satellites, the ones of the received signals being determined to be normal, and based on the position data items, estimated reception positions at which one or more of the “N” receivers are estimated to receive the signals from the plurality of satellites, and
calculating, based on the estimated posture of the mobile body and on the estimated reception positions, estimated positions of a reference point in the mobile body.

34. A method of estimating a position and a posture of a mobile body, the method comprising:
estimating the posture of the mobile body
based on observation data items generated based on signals that “N” (N is an integer number of three or more) receivers installed in the mobile body each have received from a plurality of satellites, and
based on position data items of the plurality of satellites; and
estimating the position of the mobile body based on the observation data items and on the position data items,
the observation data items including information items about distances from the plurality of satellites to the “N” receivers,
the estimating of the position of the mobile body including
calculating, based on the position data items and on the observation data items, estimated reception positions at which one or more of the “N” receivers are estimated to receive the signals from the plurality of satellites, and
calculating, based on the estimated posture of the mobile body and on the estimated reception positions, estimated positions of a reference point in the mobile body,
the estimating of the posture of the mobile body including
calculating, based on the observation data items and on the position data items, a plurality of baseline vectors in a plurality of pairs of the “N” receivers as a plurality of observation vectors, the plurality of baseline vectors each being a vector defined by two reception positions of two receivers of the “N” receivers, and
estimating the posture of the mobile body based on the plurality of calculated observation vectors, and on a plurality of reference vectors corresponding to the plurality of calculated observation vectors, the plurality of reference vectors each being the baseline vector under a state in which the posture of the mobile body is a predetermined reference posture.
